(19) United States
(12) Patent Application Publication
(10) Pub. No.: US 2022/0301193 A1
(43) Pub. Date: Sep. 22, 2022

(54) IMAGING DEVICE, IMAGE PROCESSING DEVICE, AND IMAGE PROCESSING METHOD

(71) Applicant: SONY GROUP CORPORATION, TOKYO (JP)

(72) Inventors: HIDEYUKI ICHIHASHI, TOKYO (JP); MASATOSHI YOKOKAWA, TOKYO (JP); TOMOHIRO NISHI, TOKYO (JP); YIWEN ZHU, TOKYO (JP)

(21) Appl. No.: 17/637,191

(22) PCT Filed: Jul. 20, 2020
(86) PCT No.: PCT/JP2020/028133

§ 371 Date: Feb. 22, 2022

(30) Foreign Application Priority Data
Sep. 2, 2019 (JP) 2019-159717

(51) Int. Cl. G06T 7/254; H04N 5/232; G06T 7/246

(52) U.S. Cl. CPC G06T 7/254; H04N 5/23232; G06T 7/248; G06T 2207/20212

(57) ABSTRACT

There is provided an imaging device (10) including: an imaging module (100) including an image sensor (130) in which a plurality of pixels for converting light into an electric signal is arranged; a drive unit (140) that moves a part of the imaging module in a manner that the image sensor can sequentially acquire a reference image under a predetermined pixel phase, a plurality of generation images, and a detection image under the predetermined pixel phase in this order; and a detection unit (220) that detects a moving subject based on a difference between the reference image and the detection image.

### FIELD

The present disclosure relates to an imaging device, an image processing device, and an image processing method.

### BACKGROUND

In recent years, a method has been proposed in which an image sensor is shifted to acquire a plurality of images and the acquired plurality of images is combined to generate a high-resolution image as an output image by applying a camera shake prevention mechanism provided in an imaging device. For example, as an example of such a method, a technique disclosed in Patent Literature 1 below can be exemplified.

### CITATION LIST

### Patent Literature

Patent Literature 1: WO 2019/008693 A

### SUMMARY

### Technical Problem

In the above method, in a case where a moving subject is photographed, a plurality of continuously acquired images is combined, and thus subject blurring occurs. Therefore, in a case where a moving subject is photographed, it is conceivable to switch the output mode of the output image such as outputting one image as an output image instead of combining a plurality of images in order to avoid subject blurring. Then, in a case where the switching as described above is performed, it is required to more accurately determine whether or not the moving subject (moving subject) is included in the acquired image.

Therefore, the present disclosure proposes an imaging device, an image processing device, and an image processing method capable of more accurately determining whether or not a moving subject is included.

### Solution to Problem

According to the present disclosure, provided is an imaging device including: an imaging module including an image sensor in which a plurality of pixels for converting light into an electric signal is arranged; a drive unit that moves a part of the imaging module in a manner that the image sensor can sequentially acquire a reference image under a predetermined pixel phase, a plurality of generation images, and a detection image under the predetermined pixel phase in this order; and a detection unit that detects a moving subject based on a difference between the reference image and the detection image.

Furthermore, according to the present disclosure, provided is an image processing device including: an acquisition unit that sequentially acquires a reference image under a predetermined pixel phase, a plurality of generation images, and a detection image under the predetermined pixel phase obtained by an image sensor in which a plurality of pixels for converting light into an electric signal is arranged, in this order; and a detection unit that detects a moving subject based on a difference between the reference image and the detection image.

Moreover, according to the present disclosure, provided is an image processing method including: sequentially acquiring a reference image under a predetermined pixel phase, a plurality of generation images, and a detection image under the predetermined pixel phase obtained by an image sensor in which a plurality of pixels for converting light into an electric signal is arranged, in this order; and detecting a moving subject based on a difference between the reference image and the detection image.

### BRIEF DESCRIPTION OF DRAWINGS

FIG. 1 is an explanatory diagram for explaining an example of arrangement of pixels of an image sensor.

FIG. 2 is an explanatory diagram for explaining a pixel phase.

FIG. 3 is an explanatory diagram for explaining an example of a high-resolution image generation method.

FIG. 4 is an explanatory diagram for explaining the Nyquist theorem.

FIG. 5 is an explanatory diagram for explaining a mechanism of difference generation.

FIG. 6 is an explanatory diagram for explaining a concept common to each embodiment of the present disclosure.

FIG. 7 is an explanatory diagram for explaining an example of a configuration of an imaging device according to a first embodiment of the present disclosure.

FIG. 8 is an explanatory diagram (part 1) for explaining an example of a functional block of a generation unit according to the embodiment.

FIG. 9 is an explanatory diagram (part 2) for explaining an example of the functional block of the generation unit according to the embodiment.

FIG. 10 is a flowchart illustrating a flow of an image processing method according to the embodiment.

FIG. 11 is an explanatory diagram (part 1) for explaining the image processing method according to the embodiment.

FIG. 12 is an explanatory diagram (part 2) for explaining the image processing method according to the embodiment.

FIG. 13 is an explanatory diagram (part 3) for explaining the image processing method according to the embodiment.

FIG. 14 is an explanatory diagram (part 1) for explaining an image processing method according to a modification of the embodiment.

FIG. 15 is an explanatory diagram (part 2) for explaining an image processing method according to a modification of the embodiment.

FIG. 16 is an explanatory diagram (part 3) for explaining an image processing method according to a modification of the embodiment.

FIG. 17 is an explanatory diagram for explaining an example of a configuration of an imaging device according to a second embodiment of the present disclosure.

FIG. 18 is an explanatory diagram for explaining an image processing method according to a third embodiment of the present disclosure.

FIG. 19 is an explanatory diagram for explaining a case where it is difficult to detect a moving subject.

FIG. 20 is an explanatory diagram for explaining an image processing method according to a fourth embodiment of the present disclosure.

FIG. 21 is an explanatory diagram for explaining an example of a configuration of an imaging device according to a fifth embodiment of the present disclosure.

FIG. 22 is a hardware configuration diagram illustrating an example of a computer that realizes a function of an image processing device.

### DESCRIPTION OF EMBODIMENTS

Hereinafter, preferred embodiments of the present disclosure will be described in detail with reference to the accompanying drawings. Note that, in the present specification and the drawings, components having substantially the same functional configuration are denoted by the same reference numerals, and redundant description is omitted. Furthermore, in the present specification and the drawings, similar components of different embodiments may be distinguished by adding different alphabets after the same reference numerals. However, in a case where it is not necessary to particularly distinguish each of similar components, only the same reference numeral is assigned.

Note that the description will be given in the following order.

1. History until creation of embodiments according to present disclosure

1.1. History until creation of embodiments according to present disclosure

1.2. Concept of embodiments of present disclosure

2. First Embodiment

2.1. Outline of imaging device

2.2. Details of processing unit

2.3. Details of generation unit

2.4. Image processing method

2.5. Modifications

3. Second Embodiment

4. Third Embodiment

5. Fourth Embodiment

6. Fifth Embodiment

7. Summary

8. Hardware configuration

9. Supplement

### 1. History Until Creation of Embodiments According to Present Disclosure

<1.1. History Until Creation of Embodiments According to Present Disclosure>

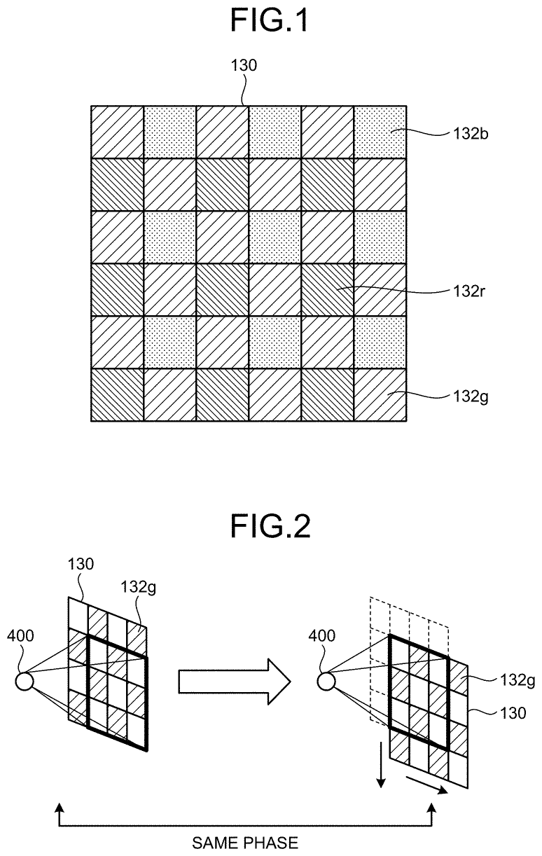

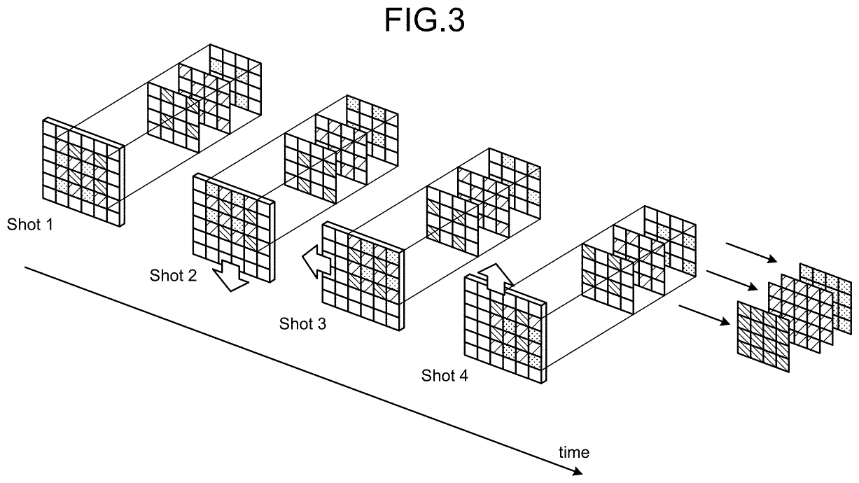

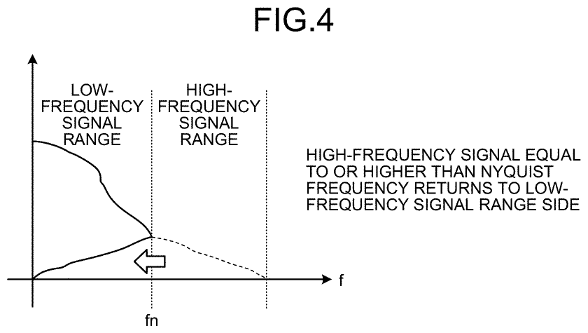

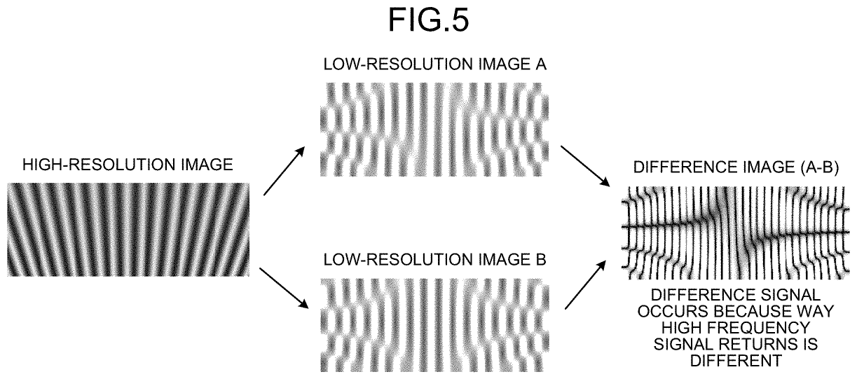

First, before describing the details of the embodiments according to the present disclosure, the history until creation of the embodiments according to the present disclosure by the present inventors will be described with reference to FIGS. 1 to 5. FIG. 1 is an explanatory diagram for explaining an example of arrangement of pixels of an image sensor, and FIG. 2 is an explanatory diagram for explaining a pixel phase. FIG. 3 is an explanatory diagram for explaining an example of a high-resolution image generation method, FIG. 4 is an explanatory diagram for explaining the Nyquist theorem, and FIG. 5 is an explanatory diagram for explaining a mechanism of difference generation.

In a charge coupled device (CCD) image sensor or a complementary metal-oxide-semiconductor (CMOS) image sensor, a configuration in which primary color filters are used and a plurality of pixels for detecting red, green, and blue light is arranged on a plane is widely used. For example, as illustrated in FIG. 1, in an image sensor unit 130, a configuration in which a plurality of pixels 132b, 132g, and 132r that detects blue, green, and red light, respectively, is arranged in a predetermined pattern (FIG. 1 illustrates an application example of the Bayer array) can be used.

That is, in the image sensor unit 130, a plurality of pixels 132 corresponding to each color is arranged in a manner that a predetermined pattern repeats. In the following description, the term “pixel phase” means a relative position of the arrangement pattern of pixels with respect to a subject indicated by an angle as a position within one cycle in a case where the above pattern is set as one cycle. Hereinafter, the definition of the “pixel phase” will be specifically described using the example illustrated in FIG. 2. Here, a case will be considered in which the image sensor unit 130 is shifted rightward and downward by one pixel from the state illustrated on the left side of FIG. 2 to the state illustrated on the right side of FIG. 2. In both cases, since the positions of the plurality of pixels 132g that detects the green light in the range surrounded by a thick frame with respect to a stationary subject 400 are the same, the pixel phases in the above definition are regarded as the same, that is, the “same phase”. In other words, “same phase” means that the position of at least a part (in detail, the pixels 132g in the range surrounded by a thick frame) of the plurality of pixels 132g in the image sensor unit 130 in the state illustrated on the left side of FIG. 2 overlaps the position of at least a part (specifically, the pixels 132g in the range surrounded by a thick frame) of the plurality of pixels 132g in the image sensor unit 130 in the state illustrated on the right side of FIG. 2.

By the way, in recent years, a method has been proposed in which the image sensor unit 130 is shifted along a predetermined direction by one pixel to acquire a plurality of images and the acquired plurality of images is combined to generate a high-resolution image by applying a camera shake prevention mechanism provided in an imaging device. In detail, as illustrated in FIG. 3, in this method, the imaging device is fixed to a tripod and the like, and for example, the image sensor unit 130 is sequentially shifted by one pixel and continuously photographed four times, and the obtained four images (illustrated on the front side of FIG. 3) are combined. Here, an image is divided (partitioned) in units of pixels of the image sensor unit 130, and a plurality of blocks is provided on the image. Then, according to the above method, the information of the three light colors of blue, green, and red acquired by the image sensor unit 130 is reflected in all the blocks on the image (illustrated on the right side of FIG. 3). In other words, in this method, there is no missing in the information of the light of each color in all the blocks on the image. Therefore, in this method, it is possible to generate a high-resolution image by directly combining the information of the light of each color without performing the interpolation processing of interpolating the information of the light of the missing color with the information of the surrounding blocks. As a result, according to the method, since the interpolation processing is not performed, it is possible to minimize the occurrence of color moire (false color) and to realize higher definition and more faithful texture depiction. Note that sequentially shifting the image sensor unit 130 by one pixel and continuously photographing can be rephrased as continuously photographing under different pixel phases.

In the image obtained by the above method, as is clear from the above description, improvement in resolution can be expected in the region of the subject 400 (stationary subject) that is stationary. On the other hand, in the region of the moving subject in the image obtained by the above method, since a plurality of images obtained by continuous photographing at different timings is combined, subject blurring occurs because of the movement of the subject 400 during continuous photographing. Therefore, in a case where a plurality of images photographed at different timings is combined as in the above method, it is conceivable to prevent subject blurring by the following method. For example, there is a method of determining whether or not a moving subject is included in an image by detecting a difference between a plurality of images acquired by the above method, and selecting not to combine the plurality of images in the region of the moving subject in a case where the moving subject is included.

However, as a result of intensive studies on the above method, the present inventors have found that a stationary subject may be misidentified as a moving subject in a method of simply detecting a difference between a plurality of images and determining whether or not a moving subject is included in an image as in the above method. Hereinafter, it will be described with reference to FIGS. 4 and 5 that a stationary subject may be misidentified as a moving subject in a method of simply detecting a difference between a plurality of images.

As illustrated in FIG. 4, a case where the original signal is discretely sampled by constraints such as the density of the pixels 132 of the image sensor unit 130 (low resolution) is considered. In this case, according to the Nyquist theorem, a signal having a frequency equal to or higher than a Nyquist frequency fn (high-frequency signal), which is included in the original signal, is mixed as a return signal (aliasing) into a low-frequency signal range of ½ (Nyquist frequency fn) or less of the sampling frequency.

Then, as illustrated in FIG. 5, in a case where a difference between a plurality of images is detected, the original signal (illustrated on the left side of FIG. 5) that is an image of the stationary subject 400 is discretely sampled, and for example, two low-resolution images A and B (illustrated in the center of FIG. 5) can be obtained. Next, in a case where a difference between these low-resolution images A and B is detected (difference image), a difference occurs as illustrated on the right side of FIG. 5 although the image is an image of a stationary subject. According to the study by the present inventors, it is considered that a difference occurs between the low-resolution images A and B since the form of mixing of the return signal is different because of a difference in the pixel phases (sampling frequency) between the low-resolution images A and B. In addition, according to the present inventors, in the method of simply detecting a difference between the plurality of images, it has been found that it is difficult to separately detect a difference due to the motion of the subject 400 and a difference due to the divergence in the mixing form of the return signal. As a result, in a method of simply detecting a difference between a plurality of images and determining whether or not a moving subject is included in an image, a difference due to the divergence in the mixing form of the return signal that is difficult to detect separately from a difference due to a moving subject is detected. Therefore, a stationary subject may be misidentified as a moving subject. Then, in a case where the above-described misidentification occurs, whether or not to combine the plurality of images is selected. Therefore, it is not possible to sufficiently utilize the method for generating a high-resolution image by combining the plurality of images described above.

<1.2. Concept of Embodiments of Present Disclosure>

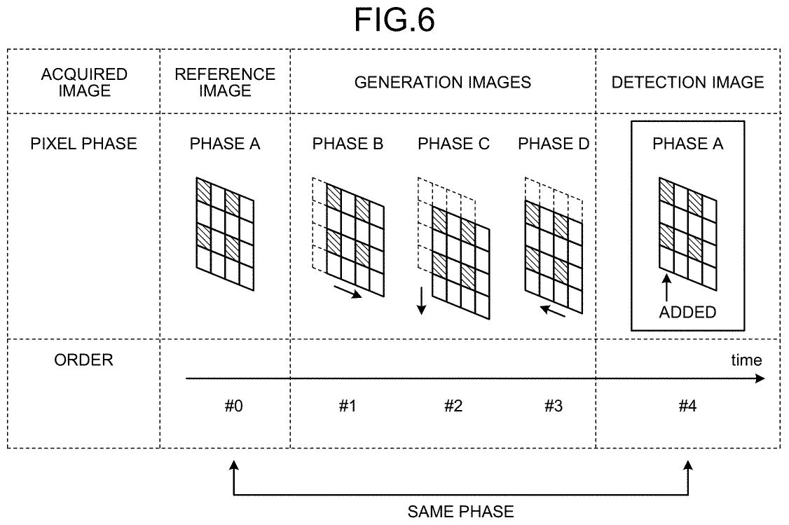

Therefore, the present inventors have created the embodiments of the present disclosure in which it is possible to prevent a stationary subject from being misidentified as a moving subject, that is, it is possible to more accurately determine whether or not a moving subject is included, by focusing on the above knowledge. Hereinafter, a concept common to the embodiments of the present disclosure will be described with reference to FIG. 6. FIG. 6 is an explanatory diagram for explaining a concept common to each embodiment of the present disclosure.

As described above, in a method of simply detecting a difference between a plurality of images and determining whether or not a moving subject is included in an image, a stationary subject may be misidentified as a moving subject. The reason for this is considered to be that, even in the case of an image of a stationary subject, a difference occurs between a plurality of images because the form of mixing of the return signal is different due to a difference in the pixel phases between the plurality of images. Therefore, the present inventors have conceived that determination of whether or not a moving subject is included in an image is performed by detecting a difference between the images of the same phase in view of the reason why a difference occurs because of the different mixing forms of the return signal.

In detail, as illustrated in FIG. 6, the present inventors have conceived that an image (a detection image #4) when the pixel phase is a phase A is newly acquired at the end in addition to the images (a reference image #0 and generation images #1 to #3) when the pixel phases are the phase A, a phase B, a phase C, and a phase D acquired in the above method for generating a high-resolution image. Then, the present inventors have created an embodiment of the present disclosure in which it is determined whether or not a moving subject is included in a series of images based on a difference between the reference image #0 and the detection image #4 having the same phase. According to such an embodiment of the present disclosure, since the reference image #0 and the detection image #4 are acquired in the same phase (phase A), the form of mixing of the return signal is the same, and there is no case where a difference occurs even though the image is an image of a stationary subject. As a result, according to the embodiment of the present disclosure, since a stationary subject is not misidentified as a moving subject, it is possible to avoid selecting not to combine a plurality of images because of misidentification, and it is possible to sufficiently utilize the method for generating a high-resolution image.

Note that, in FIG. 6, the subscript numbers #0, #1, #2, #3, and #4 of each image indicate the photographing order. In detail, FIG. 6 illustrates a case of focusing on the pixels 132r that detect red light in the image sensor unit 130 (here, the plurality of pixels 132 that detects light in each color of the image sensor unit 130 is arranged according to the Bayer array). In a case where the pixel phase at the time of acquiring the reference image #0 is the phase A, the generation image #1 is acquired in the phase B obtained by shifting the image sensor unit 130 rightward by one pixel, and the generation image #2 is acquired in the phase C obtained by shifting the image sensor unit 130 in the state of the phase B downward by one pixel. Further, the generation image #3 is acquired in the phase D obtained by shifting the image sensor unit 130 in the state of the phase C leftward by one pixel, and the detection image #4 is acquired in the phase A obtained by shifting the image sensor unit 130 in the state of the phase D upward by one pixel. Note that, in the image sensor unit 130 to which the Bayer array is applied, the case of the pixels 132b that detect blue light can be considered similarly to the pixels 132r that detect red light described above.

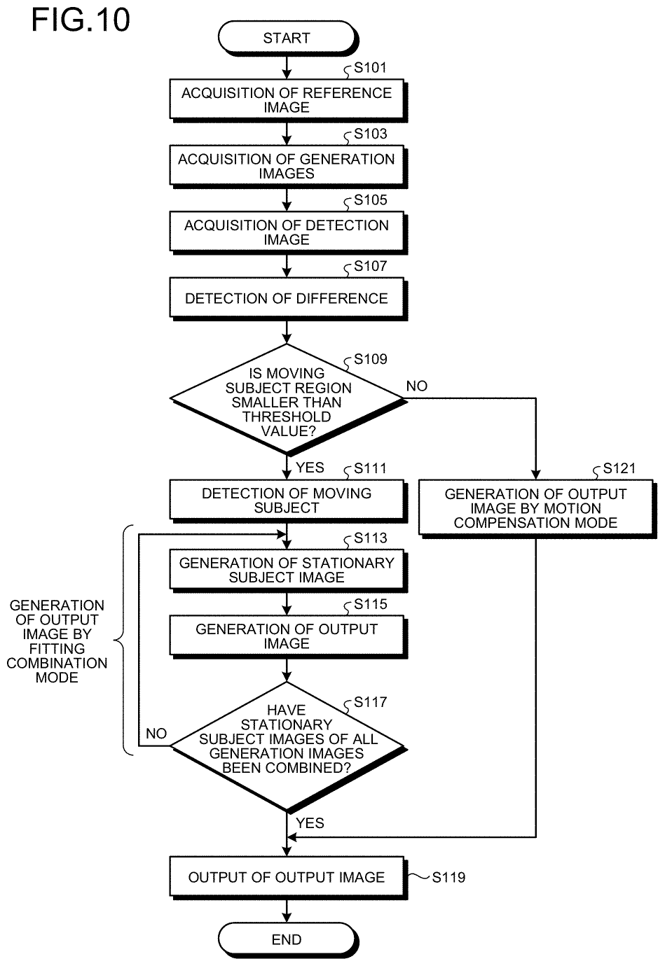

By the way, in a case where the imaging device is not fixed (for example, vibration of the ground to which the imaging device is fixed, vibration of the imaging device due to user operation, vibration of a tripod to which the imaging device is fixed, and the like), if the above method for generating a high-resolution image is to be used, an image having subject blurring as a whole is generated. That is, in a case where the imaging device is not fixed, it may be preferable not to use a method for generating a high-resolution image (in the following description, it is referred to as a fitting combination mode) in a manner that breakage (for example, subject blurring) does not occur in the generated image. Therefore, in the embodiment of the present disclosure created by the present inventors, in a case where it is detected that the imaging device is not fixed, the mode is switched to generate the output image in the motion compensation mode (see FIG. 10) in which a high-resolution image of the moving subject 400 can be obtained while suppressing an increase in the amount of data to be subjected to acquisition processing. In the motion compensation mode, the current predicted image is generated based on the high-resolution image obtained by processing the current (current frame) low-resolution image, and the immediately preceding high-resolution image (immediately preceding frame). Furthermore, in this mode, the deviation between the low-resolution predicted image obtained by processing the predicted image and the low-resolution image of the current frame is calculated, and the high-resolution image of the current frame is generated using the calculated deviation. Therefore, in this mode, it is possible to obtain a high-resolution image while suppressing an increase in the amount of data to be subjected to acquisition processing. As described above, according to the embodiment of the present disclosure, it is possible to provide a robust imaging device, image processing device, and image processing method that do not cause breakage in the generated high-resolution image even in a case where a moving subject is included. Hereinafter, such embodiments of the present disclosure will be sequentially described in detail.

### 2. First Embodiment

<2.1. Outline of Imaging Device>

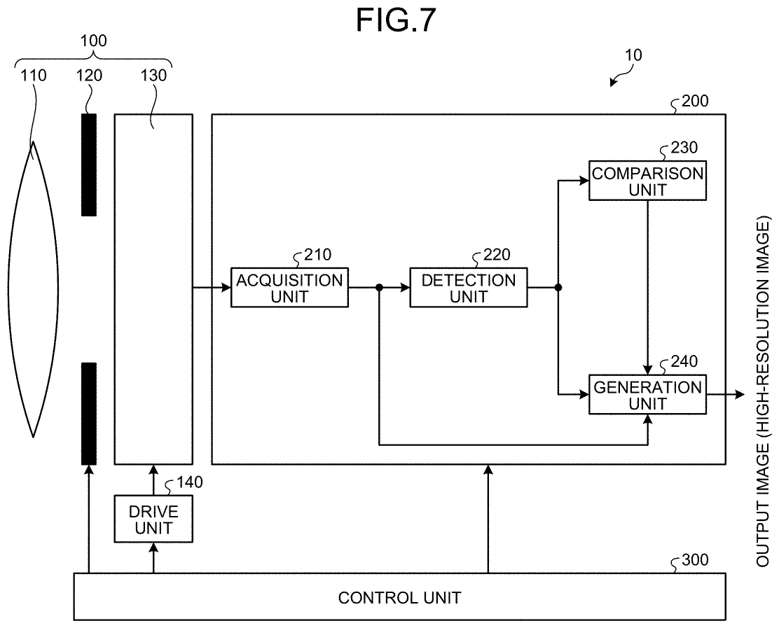

First, a configuration of an imaging device 10 according to an embodiment of the present disclosure will be described with reference to FIG. 7. FIG. 7 is an explanatory diagram for explaining an example of a configuration of the imaging device 10 according to the present embodiment. As illustrated in FIG. 7, the imaging device 10 according to the present embodiment can mainly include, for example, an imaging module 100, a processing unit (image processing device) 200, and a control unit 300. Hereinafter, an outline of each unit included in the imaging device 10 will be sequentially described.

(Imaging Module 100)

The imaging module 100 forms an image of incident light from the subject 400 on the image sensor unit 130 to supply electric charge generated in the image sensor unit 130 to the processing unit 200 as an imaging signal. In detail, as illustrated in FIG. 7, the imaging module 100 includes an optical lens 110, a shutter mechanism 120, an image sensor unit 130, and a drive unit 140. Hereinafter, details of each functional unit included in the imaging module 100 will be described.

The optical lens 110 can collect light from the subject 400 and form an optical image on the plurality of pixels 132 (see FIG. 1) on a light receiving surface of the image sensor unit 130 to be described later. The shutter mechanism 120 can control a light irradiation period and a light shielding period with respect to the image sensor unit 130 by opening and closing. For example, opening and closing of the shutter mechanism 120 is controlled by the control unit 300 to be described later.

The image sensor unit 130 can acquire an optical image formed by the above optical lens 110 as an imaging signal. Furthermore, in the image sensor unit 130, for example, acquisition of an imaging signal is controlled by the control unit 300. In detail, the image sensor unit 130 includes the plurality of pixels 132 arranged on the light receiving surface that converts light into an electric signal (see FIG. 1). The plurality of pixels 132 can be, for example, CCD image sensor elements or CMOS image sensor elements.

More specifically, as illustrated in FIG. 1, the image sensor unit 130 includes the plurality of pixels 132 arranged along the horizontal direction and the vertical direction on the light receiving surface. Further, the plurality of pixels 132 may include the plurality of pixels 132g that detects green light, the plurality of pixels 132r that detects red light, and the plurality of pixels 132b that detects blue light, which have different arrangements (arrangement patterns) on the light receiving surface. Note that, in the present embodiment, the image sensor unit 130 is not limited to including the plurality of pixels 132b, 132g, and 132r that detects blue light, green light, and red light, respectively. For example, the image sensor unit 130 may further include the plurality of pixels 132 that detects light of other colors other than the blue, green, and red light (for example, white, black, yellow, and the like), or may include the plurality of pixels 132 that detects light of other colors instead of the blue, green, and red light.

For example, in the present embodiment, as illustrated in FIG. 1, a Bayer array in which the plurality of pixels 132b, 132g, and 132r that detects blue, green, and red light, respectively, is arranged as illustrated in FIG. 1 is applied to the image sensor unit 130. In this case, in the image sensor unit 130, the number of the pixels 132g that detect green light is larger than the number of the pixels 132r that detect red light, and is larger than the number of the pixels 132b that detect blue light.

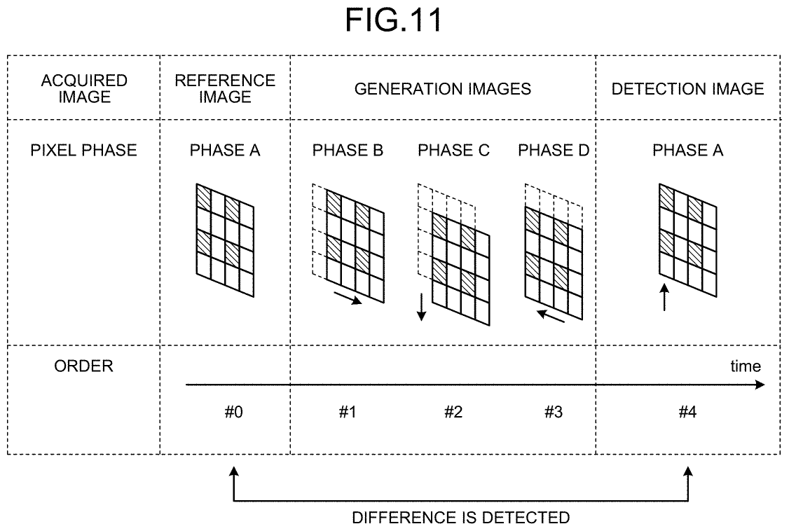

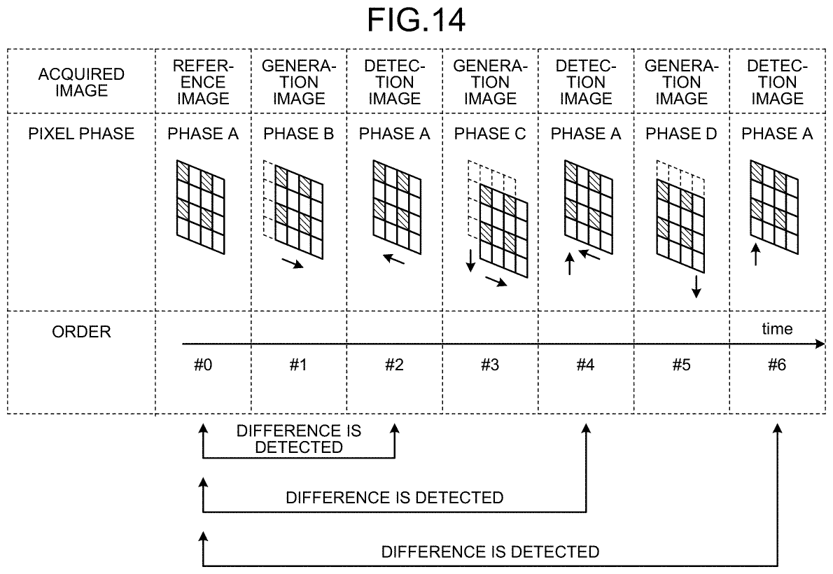

The drive unit 140 can shift the image sensor unit 130 along the arrangement direction of the pixels, in other words, can shift the image sensor unit 130 in units of pixels in the horizontal direction and the vertical direction. In addition, the drive unit 140 includes an actuator, and the shift operation (the shift direction and the shift amount) is controlled by the control unit 300 to be described later. Specifically, the drive unit 140 can move the image sensor unit 130 at least in the light receiving surface (predetermined surface) in the horizontal direction and the vertical direction by a predetermined unit (for example, by one pixel) in a manner that the reference image, the plurality of generation images, and the detection image can be sequentially acquired in this order by the image sensor unit 130 described above (see FIG. 11). At this time, the drive unit 140 moves the image sensor unit 130 in a manner that the generation image can be acquired in a phase image different from the phase image when the reference image and the detection image are acquired. In addition, the drive unit 140 can also move the image sensor unit 130 in a manner that the image sensor unit 130 can repeat sequentially acquiring the generation image and the detection image in this order (see FIG. 14).

(Processing Unit 200)

The processing unit 200 can generate a high-resolution output image based on the imaging signal from the imaging module 100 described above. The processing unit 200 is realized by, for example, hardware such as a central processing unit (CPU), a read only memory (ROM), and a random access memory (RAM). In addition, for example, in the processing unit 200, generation of an output image may be controlled by the control unit 300 to be described later. A detailed configuration of the processing unit 200 will be described later.

(Control Unit 300)

The control unit 300 can control the imaging module 100 and the processing unit 200. The control unit 300 is realized by, for example, hardware such as a CPU, a ROM, and a RAM.

Note that, in the following description, the imaging module 100, the processing unit 200, and the control unit 300 will be described as being configured as the integrated imaging device 10 (standalone). However, the present embodiment is not limited to such a standalone configuration. That is, in the present embodiment, for example, the imaging module 100, the control unit 300, and the processing unit 200 may be configured as separate units. In addition, in the present embodiment, for example, the processing unit 200 may be configured as a system including a plurality of devices on the premise of connection to a network (or communication between devices), such as cloud computing.

<2.2. Details of Processing Unit>

As described above, the processing unit 200 is a device capable of generating a high-resolution output image based on the imaging signal from the imaging module 100 described above. As illustrated in FIG. 7, the processing unit 200 mainly includes an acquisition unit 210, a detection unit 220, a comparison unit 230, and a generation unit 240. Hereinafter, details of each functional unit included in the processing unit 200 will be sequentially described.

(Acquisition Unit 210)

By acquiring the imaging signal from the imaging module 100, the acquisition unit 210 can acquire the reference image, the generation image, and the detection image sequentially obtained by the image sensor unit 130 in association with the shift direction and the shift amount (pixel phase) of the image sensor unit 130. The shift direction and the shift amount can be used for alignment and the like at the time of generating a composite image. Then, the acquisition unit 210 outputs the acquired images to the detection unit 220 and the generation unit 240 to be described later.

(Detection Unit 220)

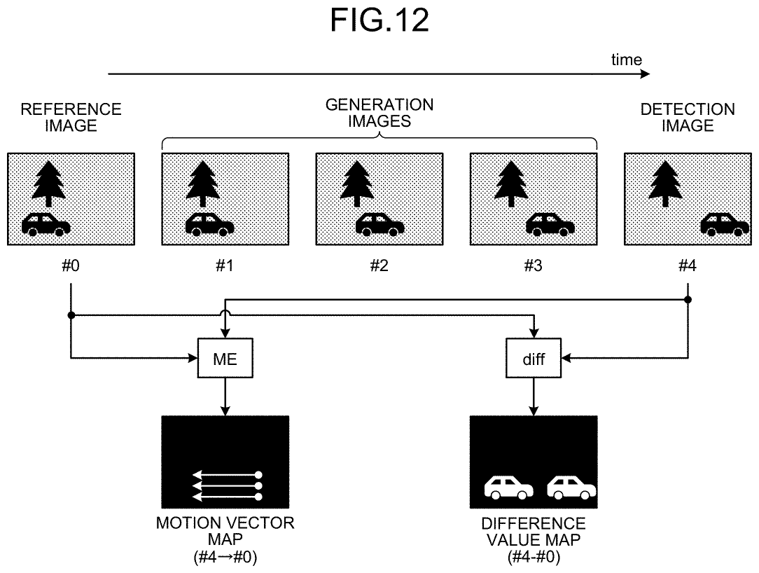

The detection unit 220 can detect a moving subject based on a difference between the reference image and one or the plurality of detection images or based on a difference between the plurality of detection images acquired in the order adjacent to each other. For example, the detection unit 220 extracts a region (difference) of different images between the reference image and the detection image, and performs binarization processing on the extracted difference image. Thus, a difference value map (see FIG. 12), in which the differences are further clarified, can be generated. Then, the detection unit 220 outputs the generated difference value map to the comparison unit 230 to be described later. Note that, in the present embodiment, since the reference image and the detection image are acquired in the same phase, the form of mixing of the return signal is the same, and there is no case where a difference occurs even though the image is an image of a stationary subject. Therefore, in a case where a difference is detected by the detection unit 220, a moving subject is included in the image.

(Comparison Unit 230)

The comparison unit 230 calculates the area of the imaging region of the moving subject based on the difference between the reference image and the detection image, and compares the area of the moving subject region corresponding to the moving subject with a predetermined threshold value. For example, the comparison unit 230 calculates the area of the image region of the moving subject in the difference value map output from the detection unit 220. Furthermore, for example, in a case where the calculated area is the same as the area of the entire image (predetermined threshold value) or larger than the area corresponding to, for example, 80% of the entire image area (predetermined threshold value), the comparison unit 230 determines that the imaging device 10 is not fixed. Then, the comparison unit 230 outputs the result of the comparison (determination) to the generation unit 240 to be described later, and the generation unit 240 switches (changes) the generation mode of the output image according to the result. Note that, in the present embodiment, the predetermined threshold value can be appropriately changed by the user.

(Generation Unit 240)

The generation unit 240 generates an output image using the plurality of generation images based on the result of detection of a moving subject by the detection unit 220 (in detail, the comparison result of the comparison unit 230). Note that a detailed configuration of the generation unit 240 will be described later.

<2.3. Details of Generation Unit>

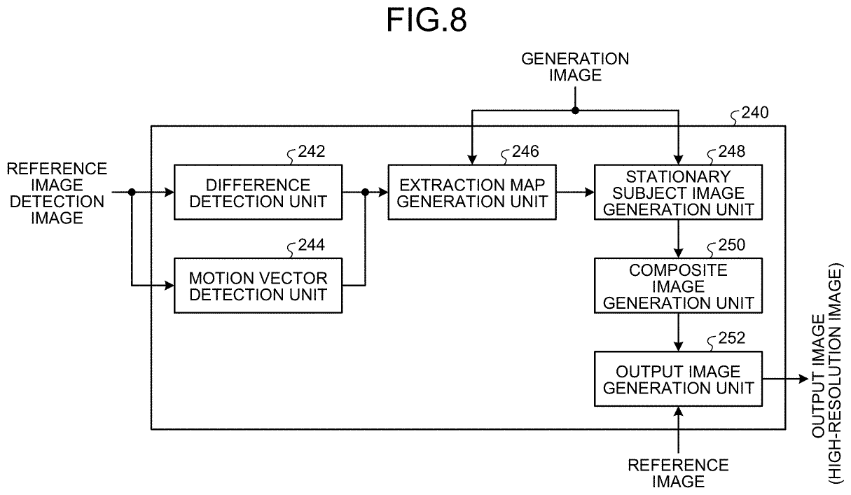

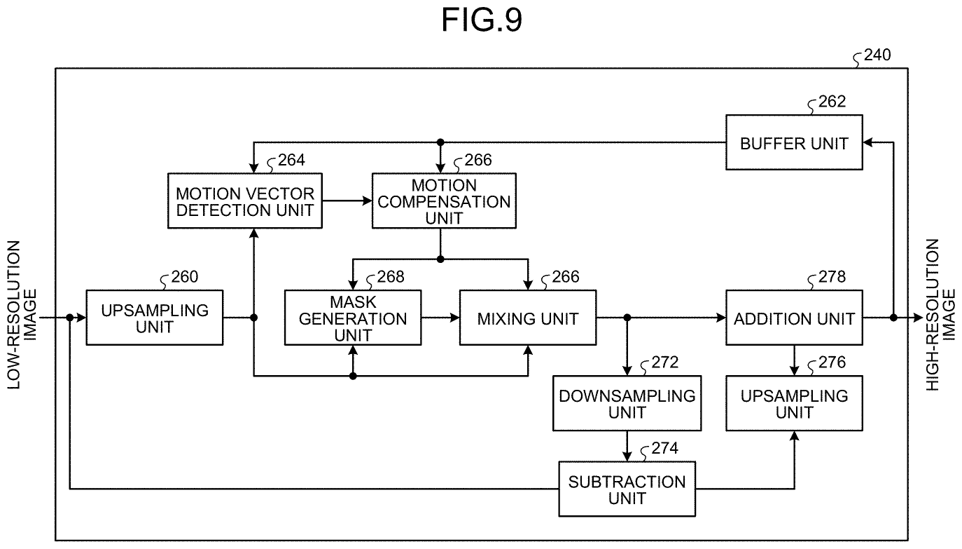

As described above, the generation unit 240 changes the generation mode of the output image based on the comparison result of the comparison unit 230. Therefore, in the following description, details of each functional unit of the generation unit 240 will be described for each generation mode with reference to FIGS. 8 and 9. FIGS. 8 and 9 are explanatory diagrams for explaining an example of a functional block of the generation unit 240 according to the present embodiment.

—Fitting Combination Mode—

In a case where the area of the moving subject region is smaller than the predetermined threshold value, the generation unit 240 generates an output image in the fitting combination mode. In the fitting combination mode, the generation unit 240 can generate a composite image by combining a plurality of stationary subject images obtained by excluding a moving subject from each of the plurality of generation images, and generate an output image by fitting the reference image into the composite image. In detail, as illustrated in FIG. 8, the generation unit 240 mainly includes a difference detection unit 242, a motion vector detection unit 244, an extraction map generation unit 246, a stationary subject image generation unit 248, a composite image generation unit 250, and an output image generation unit 252. Hereinafter, details of each functional block included in the generation unit 240 will be sequentially described.

(Difference Detection Unit 242)

The difference detection unit 242 detects a difference between the reference image and the detection image output from the acquisition unit 210 described above. Similarly to the detection unit 220 described above, the difference detection unit 242 extracts a region (difference) of different images between the reference image and the detection image, and performs binarization processing on the extracted difference image. Thus, a difference value map (see FIG. 12), in which the differences are further clarified, can be generated. Then, the difference detection unit 242 outputs the generated difference value map to the extraction map generation unit 246 to be described later. Note that, in the present embodiment, some of the functions of the difference detection unit 242 may be executed by the above detection unit 220.

(Motion Vector Detection Unit 244)

For example, the motion vector detection unit 244 divides the reference image and the detection image output from the acquisition unit 210 described above for each pixel, performs image matching for each of the divided blocks (block matching), and detects the motion vector (see FIG. 12) indicating the direction and the distance in which the moving subject moves. Then, the motion vector detection unit 244 outputs the detected motion vector to the extraction map generation unit 246 to be described later.

(Extraction Map Generation Unit 246)

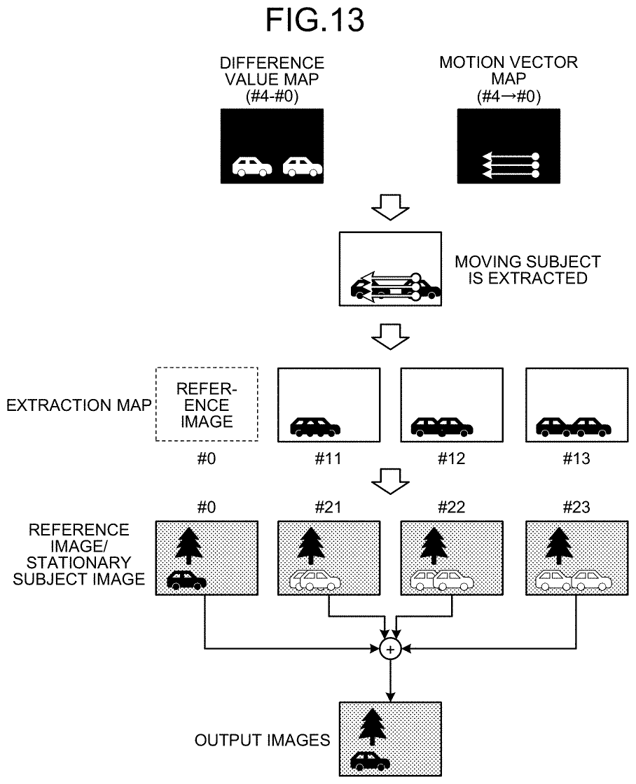

The extraction map generation unit 246 refers to the difference value map (see FIG. 12) and the motion vector (see FIG. 12) described above, and estimates the position of the moving subject on the image at the timing when each generation image is acquired based on the generation image output from the acquisition unit 210 described above. Then, the extraction map generation unit 246 generates a plurality of extraction maps #11 to #13 (see FIG. 13) including the moving subjects disposed at the estimated positions corresponding to the acquisition timings of each of the generation images #1 to #3 and the moving subject in the reference image #0. That is, the extraction maps #11 to #13 indicate the moving region of the moving subject on the image from the acquisition of the reference image #0 to the acquisition of each of the generation images #1 to #3. Note that, at the time of generating the extraction maps #11 to #13, it is preferable to refer to the shift direction and the shift amount of the image sensor unit 130 of the corresponding image and to align the reference image #0 and the generation images #1 to #3. Further, the extraction map generation unit 246 outputs the generated extraction maps #11 to #13 to the stationary subject image generation unit 248 to be described later.

(Stationary Subject Image Generation Unit 248)

The stationary subject image generation unit 248 refers to the above extraction maps #11 to #13 (see FIG. 13) and generates a plurality of stationary subject images #21 to #23 (see FIG. 13) obtained by excluding a moving subject from each of the plurality of generation images #1 to #3 output from the acquisition unit 210 described above. In detail, the stationary subject image generation unit 248 subtracts (excludes) the corresponding extraction maps #11 to #13 from each of the generation images #1 to #3. Thus, the stationary subject images #21 to #23, in which the images are partly are missing (in FIG. 13, the moving subjects are illustrated in white) can be generated. That is, in the present embodiment, by using the extraction maps #11 to #13 described above, it is possible to accurately extract only an image of the stationary subject from each of the generation images #1 to #3. Then, the stationary subject image generation unit 248 outputs the plurality of generated stationary subject images #21 to #23 to the composite image generation unit 250 to be described later.

(Composite Image Generation Unit 250)

The composite image generation unit 250 combines the plurality of stationary subject images #21 to #23 (see FIG. 13) obtained by the stationary subject image generation unit 248 described above to generate a composite image. At that time, it is preferable to refer to the shift direction and the shift amount of the image sensor unit 130 of the corresponding image and to align and combine the stationary subject images #21 to #23. Then, the composite image generation unit 250 outputs the composite image to the output image generation unit 252 to be described later.

(Output Image Generation Unit 252)

The output image generation unit 252 generates an output image by fitting the reference image #0 into the composite image obtained by the composite image generation unit 250. At this time, regarding the reference image #0 to be combined, it preferable to perform interpolation processing (for example, a process of interpolating the missing color information by the color information of blocks located around the block on the image) and fill the images of all the blocks beforehand. In the present embodiment, by doing so, even in a case where there is a missing region in all the stationary subject images #21 to #23 (see FIG. 13), the images corresponding to all the blocks can be embedded by the reference image #0, and thus, it is possible to prevent generation of an output image that is partly missing. Then, the output image generation unit 252 outputs the generated output image to another device and the like.

As described above, in the present embodiment, the output image is obtained by combining the plurality of stationary subject images #21 to #23 (see FIG. 13), that is, in the stationary subject region, a high-resolution image can be generated by directly combining the information of each color without performing the interpolation processing of interpolating the missing color information by the color information of blocks located around the block on the image. As a result, according to the present embodiment, since the interpolation processing is not performed, it is possible to minimize the occurrence of color moire and to realize higher definition and faithful texture depiction.

—Motion Compensation Mode—

In a case where the area of the moving subject region is larger than the predetermined threshold value, the generation unit 240 generates an output image in the motion compensation mode. In the motion compensation mode, the generation unit 240 predicts motion of the moving subject based on the plurality of generation images sequentially acquired by the image sensor unit 130, and can generate a high-resolution output image to which motion compensation processing based on the result of the prediction has been applied. In detail, as illustrated in FIG. 9, the generation unit 240 mainly includes upsampling units 260 and 276, a motion vector detection unit 264, a motion compensation unit 266, a mask generation unit 268, a mixing unit 270, a downsampling unit 272, a subtraction unit 274, and an addition unit 278. Hereinafter, details of each functional block included in the generation unit 240 will be sequentially described.

(Upsampling Unit 260)

The upsampling unit 260 acquires a low-resolution image (in detail, the low-resolution image in the current frame) from the acquisition unit 210 described above, and upsamples the acquired low-resolution image to the same resolution as that of the high-resolution image. Then, the upsampling unit 260 outputs the upsampled high-resolution image to the motion vector detection unit 264, the mask generation unit 268, and the mixing unit 270.

(Buffer Unit 262)

The buffer unit 262 holds the high-resolution image of the immediately preceding frame obtained by the processing immediately before the current frame, and outputs the held image to the motion vector detection unit 264 and the motion compensation unit 266.

(Motion Vector Detection Unit 264)

The motion vector detection unit 264 detects a motion vector from the upsampled high-resolution image from the upsampling unit 260 and the high-resolution image from the buffer unit 262 described above. Note that a method similar to that of the motion vector detection unit 244 described above can be used for the detection of the motion vector by the motion vector detection unit 264. Then, the motion vector detection unit 264 outputs the detected motion vector to the motion compensation unit 266 to be described later.

(Motion Compensation Unit 266)

The motion compensation unit 266 refers to the motion vector from the motion vector detection unit 264 and the high-resolution image of the immediately preceding frame from the buffer unit 262, predicts the high-resolution image of the current frame, and generates a predicted image. Then, the motion compensation unit 266 outputs the predicted image to the mask generation unit 268 and the mixing unit 270.

(Mask Generation Unit 268)

The mask generation unit 268 detects a difference between the upsampled high-resolution image from the upsampling unit 260 and the predicted image from the motion compensation unit 266, and generates a mask that is an image region of the moving subject. A method similar to that of the detection unit 220 described above can be used for the detection of the difference in the mask generation unit 268. Then, the mask generation unit 268 outputs the generated mask to the mixing unit 270.

(Mixing Unit 270)

The mixing unit 270 refers to the mask from the mask generation unit 268, performs weighting on the predicted image and the upsampled high-resolution image, and mixes the predicted image and the upsampled high-resolution image according to the weighting to generate a mixed image. Then, the mixing unit 270 outputs the generated mixed image to the downsampling unit 272 and the addition unit 278. In the present embodiment, in the generation of the mixed image, it is preferable to avoid failure in the final image caused by an error in prediction by the motion compensation unit 266 by weighting and mixing the upsampled high-resolution image in a manner that the upsampled high-resolution image is largely reflected in the moving subject image region (mask) with motion.

(Downsampling Unit 272)

The downsampling unit 272 downsamples the mixed image from the mixing unit 270 to the same resolution as that of the low-resolution image, and outputs the downsampled low-resolution image to the subtraction unit 274.

(Subtraction Unit 274)

The subtraction unit 274 generates a difference image between the low-resolution image of the current frame from the acquisition unit 210 described above and the low-resolution image from the downsampling unit 272, and outputs the difference image to the upsampling unit 276. The difference image indicates a difference in the predicted image with respect to the low-resolution image of the current frame, that is, an error due to prediction.

(Upsampling Unit 276)

The upsampling unit 276 upsamples the difference image from the subtraction unit 274 to the same resolution as that of the high-resolution image, and outputs the upsampled difference image to the addition unit 278 to be described later.

(Addition Unit 278)

The addition unit 278 adds the mixed image from the mixing unit 270 and the upsampled difference image from the upsampling unit 276, and generates a final high-resolution image of the current frame. The generated high-resolution image is output to the buffer unit 262 described above as an image of the immediately preceding frame in the processing of the next frame, and is also output to another device.

As described above, according to the present embodiment, by adding the error of the low-resolution image based on the prediction with respect to the low-resolution image of the current frame obtained by the imaging module 100 to the mixed image from the mixing unit 270, it is possible to obtain a high-resolution image closer to the high-resolution image of the current frame to be originally obtained.

<2.4. Image Processing Method>

The imaging device 10 according to the present embodiment and the configuration of each unit included in the imaging device 10 have been described in detail above. Next, the image processing method according to the present embodiment will be described. Hereinafter, the image processing method in the present embodiment will be described with reference to FIGS. 10 to 13. FIG. 10 is a flowchart illustrating a flow of an image processing method according to the embodiment, and FIGS. 11 to 13 are explanatory diagrams for explaining the image processing method according to the present embodiment. As illustrated in FIG. 10, the image processing method according to the present embodiment includes a plurality of steps from Step S101 to Step S121. Hereinafter, details of each step included in the image processing method according to the present embodiment will be described.

Note that, in the following description, a case where the present embodiment is applied to the pixels 132r that detect red light in the image sensor unit 130 will be described. That is, in the following, a case where a moving subject is detected by an image by the plurality of pixels 132r that detects red light will be described as an example. In the present embodiment, for example, by detecting a moving subject by an image by one type of the pixel 132 among the three types of the pixels 132b, 132g, and 132r that detect blue, green, and red light, an increase in processing amount for detection can be suppressed. Note that, in the present embodiment, detection of a moving subject may be performed by an image by the pixels 132b that have an arrangement pattern similar to that of the pixels 132r and detect blue light, instead of the pixels 132r that detect red light. Even in this case, the detection can be performed similarly to the case of detecting by the image by the pixels 132r to be described below.

(Step S101)

First, the imaging device 10 acquires the reference image #0, for example, in phase A (predetermined pixel phase) (see FIG. 11).

(Step S103)

As illustrated in FIG. 11, the imaging device 10 shifts the image sensor unit 130 along the arrangement direction (horizontal direction, vertical direction) of the pixels 132, for example, by one pixel (predetermined shift amount), and sequentially acquires the generation images #1, #2, and #3 in the phase B, the phase C, and the phase D, which are the pixel phases other than the phase A (predetermined pixel phase).

(Step S105)

As illustrated in FIG. 11, the imaging device 10 shifts the image sensor unit 130 along the arrangement direction (horizontal direction, vertical direction) of the pixels 132, for example, by one pixel (predetermined shift amount), and acquires the detection image #4 in the phase A (predetermined pixel phase).

In this way, for example, in the example illustrated in FIG. 12, each image (the reference image #0, the generation images #1, #2, and #3, and the detection image #4) including the traveling vehicle as a moving subject and the background tree as a stationary subject can be obtained in Steps S101 to S105 described above. In the example illustrated in FIG. 12, since time elapses between the acquisition of the reference image #0 and the acquisition of the detection image #4, the vehicle moves during the time, and thus a difference occurs between the reference image #0 and the detection image #4.

(Step S107)

The imaging device 10 detects a difference between the reference image #0 acquired in Step S101 and the detection image #4 acquired in Step S105. In detail, as illustrated in the lower right part of FIG. 12, the imaging device 10 detects a difference between the reference image #0 and the detection image #4 and generates a difference value map indicating the difference (in the example of FIG. 12, the imaging region of the traveling vehicle is illustrated as a difference).

In the present embodiment, since the reference image #0 and the detection image #4 are acquired in the same phase (phase A), the form of mixing of the return signal is the same, and thus a difference due to a difference in the form of mixing of the return signal does not occur. Therefore, according to the present embodiment, since it is possible to prevent a stationary subject from being misidentified as a moving subject because of the different mixing forms of the return signal, it is possible to accurately detect the moving subject.

(Step S109)

The imaging device 10 detects a moving subject based on the difference value map generated in Step S107 described above. In detail, the imaging device 10 calculates the area of the imaging region of the moving subject, and compares the area of the moving subject region corresponding to the moving subject with, for example, the area corresponding to 80% of the area of the entire image (predetermined threshold value). In the present embodiment, in a case where the area of the moving subject region is larger than the predetermined threshold value, it is assumed that the imaging device 10 is not fixed. Therefore, the generation mode of the output image is switched from the fitting combination mode to the motion compensation mode. In detail, in a case where the area of the moving subject region is smaller than the predetermined threshold value, the process proceeds to Step S111 of performing the fitting combination mode, and in a case where the area of the moving subject region is larger than the predetermined threshold value, the process proceeds to Step S121 of performing the motion compensation mode.

(Step S111)

Next, the imaging device 10 divides (partitions) the reference image #0 acquired in Step S101 and the detection image #4 acquired in Step S105 in units of pixels, performs image matching for each divided block (block matching), and detects a motion vector indicating the direction and distance in which a moving subject moves. Then, the imaging device 10 generates a motion vector map as illustrated in the lower left part of FIG. 12 based on the detected motion vector (in the example of FIG. 12, a motion vector indicating the direction and distance in which the traveling vehicle moves is illustrated).

Then, as illustrated in the third row from the top in FIG. 13, the imaging device 10 refers to the generated difference value map and motion vector map, and estimates the position of the moving subject on the image at the timing when each of the generation images #1 to #3 is acquired based on each of the generation images #1 to #3. Then, the imaging device 10 generates the plurality of extraction maps #11 to #13 including the moving subjects disposed at the estimated positions corresponding to the acquisition timings of each of the generation images #1 to #3 and the moving subject in the reference image #0. That is, the extraction maps #11 to #13 indicate the moving region of the moving subject on the image from the acquisition of the reference image #0 to the acquisition of each of the generation images #1 to #3.

(Step S113)

As illustrated in the fourth row from the top in FIG. 13, the imaging device 10 generates the plurality of stationary subject images #21 to #23 obtained by excluding a moving subject from each of the plurality of generation images #1 to #3 based on the extraction maps #11 to #13 generated in Step S111 described above. In detail, the imaging device 10 subtracts the corresponding extraction maps #11 to #13 from each of the generation images #1 to #3. Thus, the stationary subject images #21 to #23, in which the images are partly are missing (illustrated in white in FIG. 13) can be generated. In the present embodiment, by using the above extraction maps #11 to #13, it is possible to accurately generate stationary subject images #21 to #23 including the stationary subject 400 from each of the generation images #1 to #3.

(Step S115)

As illustrated in the lower part of FIG. 13, the imaging device 10 combines the plurality of stationary subject images #21 to #23 generated in Step S113 described above to generate a composite image. Furthermore, the imaging device 10 generates an output image by fitting the reference image #0 into the obtained composite image. At this time, regarding the reference image #0 to be combined, it preferable to perform interpolation processing (for example, a process of interpolating the missing color information by the color information of blocks located around the block on the image) and fill the images of all the blocks beforehand. In the present embodiment, even in a case where there is a missing image region in all the stationary subject images #21 to #23, the image can be embedded by the reference image #0, and thus, it is possible to prevent generation of an output image that is partly missing.

(Step S117)

The imaging device 10 determines whether or not the stationary subject images #21 to #23 corresponding to all the generation images #1 to #3 are combined in the output image generated in Step S115 described above. In a case where it is determined that the images related to all the generation images #1 to #3 are combined, the process proceeds to Step S119, and in a case where it is determined that the images related to all the generation images #1 to #3 are not combined, the process returns to Step S113.

(Step S119)

The imaging device 10 outputs the generated output image to, for example, another device and the like, and ends the processing.

(Step S121)

As described above, in the present embodiment, in a case where the area of the moving subject region is larger than the predetermined threshold value, it is assumed that the imaging device 10 is not fixed. Therefore, the generation mode of the output image is switched from the fitting combination mode to the motion compensation mode. In the motion compensation mode, as described above, the motion of the moving subject is predicted based on the plurality of generation images sequentially acquired, and a high-resolution output image to which motion compensation processing based on the result of the prediction has been applied can be generated.

To briefly describe the processing in the motion compensation mode, first, the imaging device 10 upsamples the low-resolution image in the current frame to the same resolution as that of the high-resolution image, and detects the motion vector from the upsampled high-resolution image and the held high-resolution image of the immediately preceding frame. Next, the imaging device 10 refers to the motion vector and the high-resolution image of the immediately preceding frame, predicts the high-resolution image of the current frame, and generates a predicted image. Then, the imaging device 10 detects a difference between the upsampled high-resolution image and the predicted image, and generates a mask that is a region of the moving subject. Further, the imaging device 10 refers to the generated mask, performs weighting on the predicted image and the upsampled high-resolution image, and mixes the predicted image and the upsampled high-resolution image according to the weighting to generate a mixed image. Next, the imaging device 10 downsamples the mixed image to the same resolution as that of the low-resolution image, and generates a difference image between the downsampled mixed image and the low-resolution image of the current frame. Then, the imaging device 10 upsamples the difference image to the same resolution as that of the high-resolution image and adds the upsampled difference image to the above mixed image to generate a final high-resolution image of the current frame. In the motion compensation mode of the present embodiment, by adding the error of the low-resolution image based on the prediction with respect to the low-resolution image of the current frame to the mixed image, it is possible to obtain a high-resolution image closer to the high-resolution image of the current frame to be originally obtained.

Furthermore, the imaging device 10 proceeds to Step S119 described above. According to the present embodiment, by switching the generation mode of the output image, even in a case where it is assumed that the imaging device 10 is not fixed, it is possible to provide a robust image without breakage in the generated image.

As described above, according to the present embodiment, since the reference image #0 and the detection image #4 are acquired in the same phase (phase A), the form of mixing of the return signal is the same, and thus a difference due to a difference in the form of mixing of the return signal does not occur. Therefore, according to the present embodiment, since it is possible to prevent a stationary subject from being misidentified as a moving subject because of the different mixing forms of the return signal, it is possible to accurately detect the moving subject. As a result, according to the present embodiment, it is possible to generate a high-resolution image without breakage in the generated image.

Furthermore, in the present embodiment, by detecting a moving subject by an image by one type of the pixel 132r (or the pixel 132b) among the three types of the pixels 132b, 132g, and 132r that detect blue, green, and red light, an increase in processing amount for detection can be suppressed.

<2.5. Modifications>

The details of the first embodiment have been described above. Next, various modifications according to the first embodiment will be described. Note that the following modifications are merely examples of the first embodiment, and the first embodiment is not limited to the following examples.

(Modification 1)

In the present embodiment, in a case where it is desired to more accurately detect a moving subject moving at high speed or moving at changing speed, it is possible to add acquisition of the detection image while acquiring the plurality of generation images. Hereinafter, modification 1 in which the acquisition of the detection image is added will be described with reference to FIG. 14. FIG. 14 is an explanatory diagram for explaining an image processing method according to a modification of the present embodiment.

In the present modification, as illustrated in FIG. 14, in addition to the acquisition of the reference image #0 in the phase A, the plurality of generation images #1, #3, and #5 in the phase B, the phase C, and the phase D, and a detection image #6 in the phase A, the acquisition of detection images #2 and #4 in the phase A is added during the acquisition of the plurality of generation images #1, #3, and #5. That is, in the present modification, the image sensor unit 130 is sequentially shifted along the arrangement direction (horizontal direction, vertical direction) of the pixels 132 by one pixel (predetermined shift amount) in a manner that sequentially acquiring the generation image and the detection image in this order can be repeated.

Furthermore, in the present modification, in order to detect a moving subject, a difference between the reference image #0 and the detection image #2 is taken, a difference between the reference image #0 and the detection image #4 is taken, and a difference between the reference image #0 and the detection image #6 is taken. Then, in the present modification, a moving subject can be detected without fail even if the moving subject moves at high speed or moves at changing speed by detecting the moving subject by the plurality of differences.

Furthermore, in the present modification, it is possible to detect a motion vector at the timing of acquiring each of the detection images #2 and #4 with respect to the reference image #0. Therefore, according to the present modification, by using the plurality of motion vectors, it is possible to estimate the position of the moving subject on the image at the timing when each of the generation images #1, #3, and #5 is acquired (Step S111). For example, even in a case where the moving speed of the moving subject changes during the period from the acquisition of the reference image #0 to the acquisition of the last detection image #6, according to the present modification, by using the plurality of motion vectors in each stage, the accuracy of the estimation of the position of the moving subject on the image at the timing when each of the generation images #1, #3, and #5 is acquired can be improved. As a result, according to the present modification, since the estimation accuracy is improved, the extraction map corresponding to each of the generation images #1, #3, and #5 can be generated accurately, and furthermore, the stationary subject image can be generated accurately.

That is, according to this modification, it is possible to more accurately detect a moving subject and accurately generate a stationary subject image from each of the generation images #1, #3, and #5. As a result, according to the present modification, a stationary subject is not misidentified as a moving subject and it is possible to generate a high-resolution image without breakage in the generated image.

(Modification 2)

In addition, in the first embodiment described above, the detection image #4 is acquired after the reference image #1 and the generation images #1 to #3 are acquired. However, the present embodiment is not limited to acquiring the detection image #4 at the end. For example, in the present embodiment, by combining the motion prediction, the detection image #4 may be acquired while the generation images #1 to #3 are acquired. In this case, the motion vector of the moving subject is detected using the reference image #0 and the detection image #4, the position of the moving subject in the generation image acquired after the detection image #4 is acquired is predicted with reference to the detected motion vector, and the extraction map is generated.

(Modification 3)

Furthermore, in the first embodiment described above, in Step S109, in a case where the area of the moving subject region is larger than the predetermined threshold value, it is assumed that the imaging device 10 is not fixed. Therefore, the processing has been switched from the fitting combination mode to the motion compensation mode. However, in the present embodiment, the mode is not automatically switched, and the user may finely set in which mode the processing is performed for each region of the image beforehand. In this way, according to the present modification, the freedom of expression of the user who is the photographer can be further expanded.

(Modification 4)

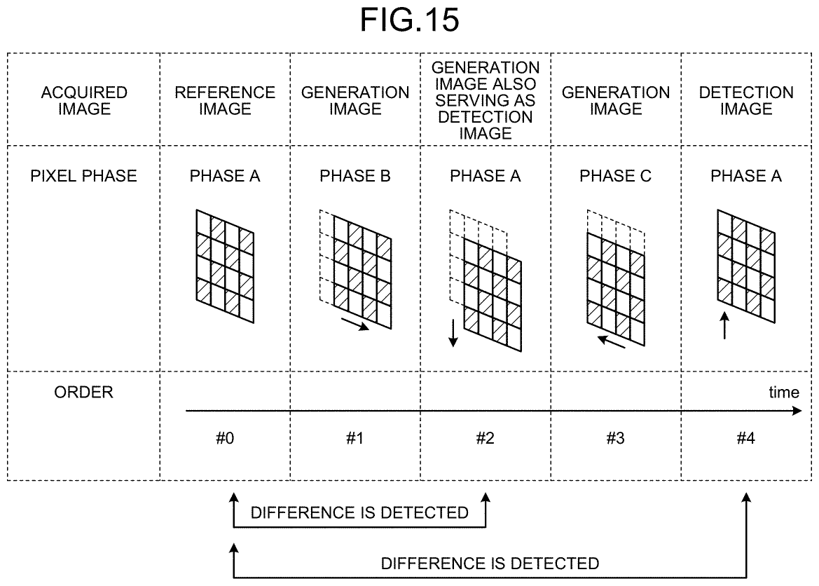

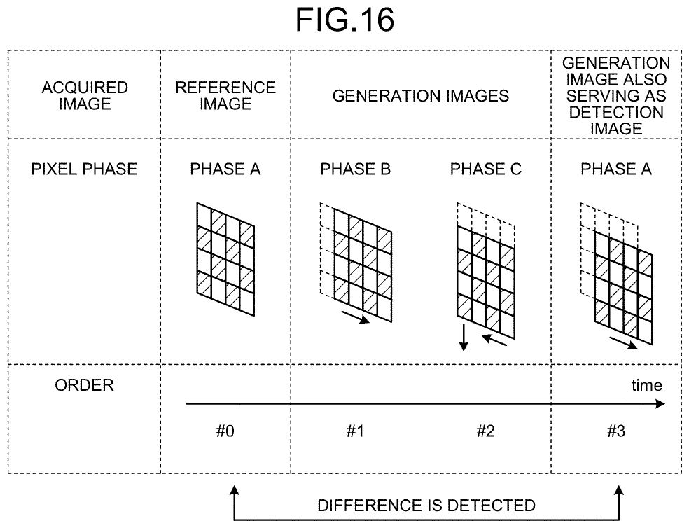

Furthermore, in the present embodiment, the moving subject may be detected by an image by the pixels 132g that detect green light instead of the pixels 132r that detect red light. Therefore, a modification of the present embodiment in which a moving subject is detected in an image by the pixels 132g that detect green light will be described below with reference to FIGS. 15 and 16. FIGS. 15 and 16 are explanatory diagrams for explaining an image processing method according to a modification of the present embodiment.

For example, in the present embodiment, in a case of the image sensor unit 130 having a Bayer array as illustrated in FIG. 1, in the image sensor unit 130, the number of the pixels 132g that detect green light is larger than the number of the pixels 132r that detect red light, and is larger than the number of the pixels 132b that detect blue light. Therefore, since the arrangement pattern of the pixel 132g is different from the arrangement pattern of the pixels 132b and 132r, in the pixels 132g that detects green light, the type of pixel phase is also different from that of the pixels 132b and 132r.

Therefore, in the present modification, as illustrated in FIG. 15, the image sensor unit 130 is shifted to sequentially acquire the reference image #0, the generation images #1 to #3, and the detection image #4. In detail, in a case where the pixel phase at the time of acquiring the reference image #0 is the phase A, the generation image #1 is acquired in the phase B obtained by shifting the image sensor unit 130 rightward by one pixel. Next, in a state where the image sensor unit 130 in the state of the phase B is shifted downward by one pixel, the generation image #2 is acquired, but since this state is in the same phase as the phase A, the generation image #2 can also be a detection image. Next, the generation image #3 is acquired in the phase C obtained by shifting the image sensor unit 130 in the state of the phase A of the generation image #2 leftward by one pixel. Further, the detection image #4 is acquired in the phase A obtained by shifting the image sensor unit 130 in the state of the phase C upward by one pixel.

Furthermore, in the present modification, as illustrated in FIG. 15, in order to detect a moving subject, not only the difference between the reference image #0 and the detection image #4 can be taken, but also the difference between the reference image #0 and the generation image #2 also serving as the detection image can be taken. Therefore, in the present modification, the moving subject can be detected without fail by referring to the plurality of differences and detecting the moving subject.

Furthermore, in the present modification, as illustrated in FIG. 16, the image sensor unit 130 may be shifted to sequentially acquire the reference image #0, the generation images #1 and #2, and a detection image #3. That is, in the example of FIG. 16, the generation image #2 also serving as the detection image in FIG. 15 described above is acquired at the end, in a manner that the acquisition of the detection image #4 can be omitted.

In detail, as illustrated in FIG. 16, in a case where the pixel phase at the time of acquiring the reference image #0 is the phase A, the generation image #1 is acquired in the phase B obtained by shifting the image sensor unit 130 rightward by one pixel. Next, the generation image #2 is acquired in phase C obtained by shifting the image sensor unit 130 in the state of the phase B downward and rightward by one pixel. Then, the generation image #3 also serving as the detection image is acquired in the phase A obtained by shifting the image sensor unit 130 in the state of the phase C rightward by one pixel. That is, in the example of FIG. 16, since the number of images used to generate the high-resolution image can be reduced while detecting the moving subject, an increase in the processing amount can be suppressed, and the output image can be obtained in a short time. Note that, in the case of the present modification, as illustrated in FIG. 16, in order to detect a moving subject, a difference between the reference image #0 and the detection image #3 is taken.

### 3. Second Embodiment

In the first embodiment described above, a moving subject is detected by an image by the pixels 132r that detect red light (alternatively, the pixels 132b or the pixels 132g). By doing so, in the first embodiment, an increase in the processing amount for detection is suppressed. However, the present disclosure is not limited to detection of a moving subject by an image by one type of pixel 132, and detection of a moving subject may be performed by images by three pixels 132b, 132g, and 132r that detect blue, green, and red light. By doing so, the accuracy of the detection of the moving subject can be further improved. Hereinafter, details of such a second embodiment of the present disclosure will be described.

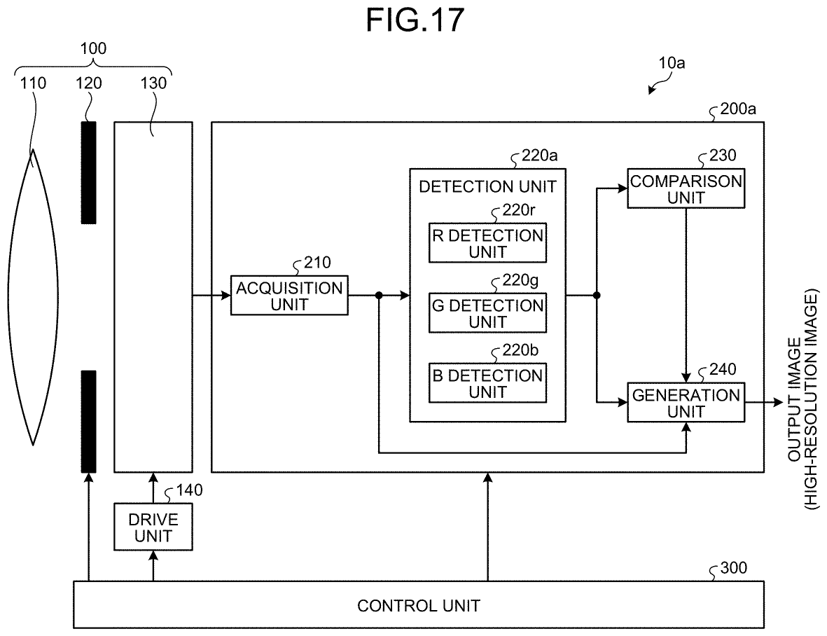

First, details of a processing unit 200a according to the second embodiment of the present disclosure will be described with reference to FIG. 17. FIG. 17 is an explanatory diagram for explaining an example of a configuration of an imaging device according to the present embodiment. In the following description, description of points common to the first embodiment described above will be omitted, and only different points will be described.

In the present embodiment, as described above, a moving subject is detected by each image of the three pixels 132b, 132g, and 132r that detect blue, green, and red light. Therefore, the processing unit 200a of an imaging device 10a according to the present embodiment includes three detection units 220b, 220g, and 220r in a detection unit 220a. In detail, the B detection unit 220b detects a moving subject by an image by the pixels 132b that detect blue light, the G detection unit 220g detects a moving subject by an image by the pixels 132g that detect green light, and the R detection unit 220r detects a moving subject by an image by the pixels 132r that detect red light. Note that, since the method for detecting a moving subject in an image of each color has been described in the first embodiment, a detailed description will be omitted here.

In the present embodiment, since a moving subject is detected by each image by the three pixels 132b, 132g, and 132r that detect blue, green, and red light, even a moving subject that is difficult to detect depending on the color can be detected without fail by performing detection using images corresponding to a plurality of colors. That is, according to the present embodiment, the accuracy of detection of a moving subject can be further improved.

Note that, in the present embodiment, detection of a moving subject is not limited to being performed by each image by the three pixels 132b, 132g, and 132r that detect blue, green, and red light. For example, in the present embodiment, a moving subject may be detected by an image by two types of pixels 132 among the three pixels 132b, 132g, and 132r. In this case, it is possible to suppress an increase in processing amount for detection while preventing leakage of detection of the moving subject.

### 4. Third Embodiment

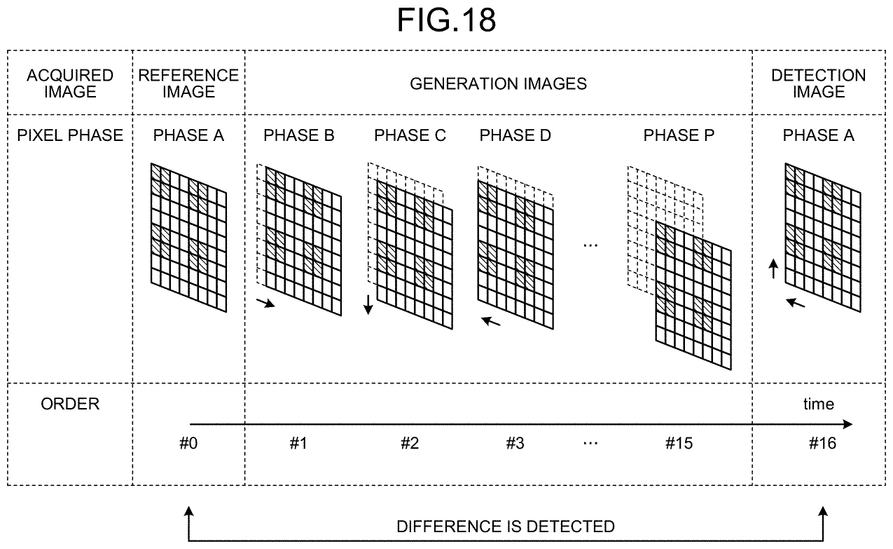

In the first embodiment described above, the image sensor unit 130 is shifted along the arrangement direction of the pixels 132 by one pixel, but the present disclosure is not limited to shifting by one pixel, and for example, the image sensor unit 130 may be shifted by 0.5 pixels. Note that, in the following description, shifting the image sensor unit 130 by 0.5 pixels means shifting the image sensor unit 130 along the arrangement direction of the pixels by a distance of half of one side of one pixel. Hereinafter, an image processing method in such a third embodiment will be described with reference to FIG. 18. FIG. 18 is an explanatory diagram for explaining an image processing method according to the present embodiment. Note that, in FIG. 18, for easy understanding, the image sensor unit 130 is illustrated as having a square of 0.5 pixels as one unit.

In addition, in the following description, a case where the present embodiment is applied to the pixels 132r that detect red light in the image sensor unit 130 will be described. That is, in the following, a case where a moving subject is detected by an image by the pixels 132r that detect red light will be described as an example. Note that, in the present embodiment, detection of a moving subject may be performed by an image by the pixels 132b that detect blue light or may be performed by an image by the pixels 132g that detect green light, instead of the pixels 132r that detect red light.

In detail, in the present embodiment, as illustrated in FIG. 18, in a case where the pixel phase at the time of acquiring the reference image #0 is the phase A, the generation image #1 is acquired in the phase B obtained by shifting the image sensor unit 130 rightward by 0.5 pixels. Then, the generation image #2 is acquired in the phase C obtained by shifting the image sensor unit 130 in the state of the phase B downward by 0.5 pixels. Further, generation image #3 is acquired in the phase D obtained by shifting the image sensor unit 130 in the state of phase D leftward by 0.5 pixels. As described above, in the present embodiment, by sequentially shifting the image sensor unit 130 along the arrangement direction of the pixels 132 by 0.5 pixels, it is possible to acquire images in a total of 16 pixel phases (phases A to P). Then, in the present embodiment, the image sensor unit 130 is shifted along the arrangement direction of the pixels 132 by 0.5 pixels at the end to be in the state of the phase A again, and a detection image #16 is acquired.

As described above, according to the present embodiment, by finely shifting the image sensor unit 130 by 0.5 pixels, it is possible to acquire more generation images, and thus, it is possible to generate a high-resolution image with higher definition. Note that the present embodiment is not limited to shifting the image sensor unit 130 by 0.5 pixels, and for example, the image sensor unit 130 may be shifted by another shift amount such as by 0.2 pixels (in this case, the image sensor unit 130 is shifted by a distance of ⅕ of one side of one pixel).

### 5. Fourth Embodiment

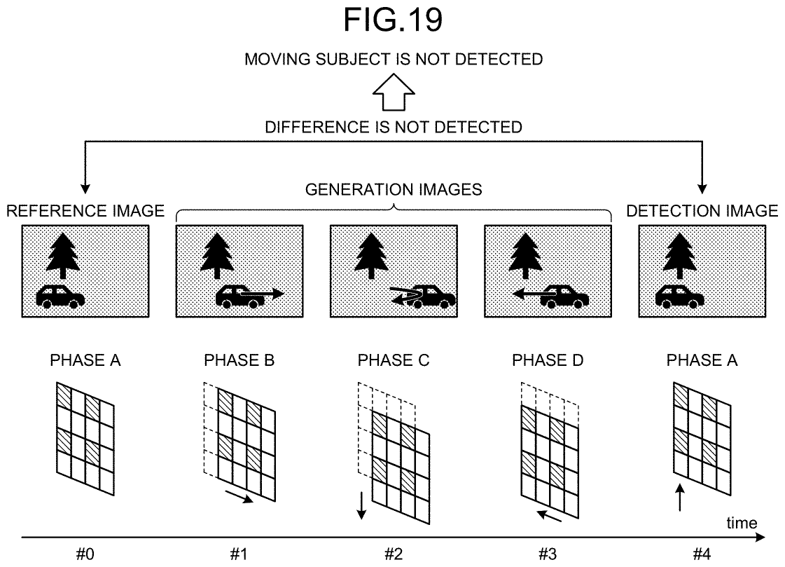

By the way, in each of the above embodiments, in a case where the time between the timing of acquiring the reference image and the timing of acquiring the last detection image becomes long, there is a case where it is difficult to detect a moving subject because the moving subject does not move at constant speed. For example, a case where it is difficult to detect a moving subject will be described with reference to FIG. 19. FIG. 19 is an explanatory diagram for explaining a case where it is difficult to detect a moving subject.

In detail, as illustrated in FIG. 19, as an example of a case where it is difficult to detect a moving subject, the state of the vehicle included in the reference image #0 moves forward at the timing when the generation image #1 is acquired, and is switched from forward movement to backward movement at the timing when the generation image #2 is acquired. Furthermore, in this example, the vehicle further moves backward at the timing when the generation image #3 is acquired, and is at the same position as the timing when the reference image #0 is acquired at the timing when the detection image #4 is acquired. In such a case, since no difference is detected between the reference image #0 and the detection image #4, it is determined that the vehicle is stopped, and the moving subject cannot be detected. In a case where the moving subject does not move at constant speed in the same direction between the timing of acquiring the reference image #0 and the timing of acquiring the detection image #, the difference between the reference image #0 and the detection image #4 cannot interpolate the motion of the moving subject in each generation image acquired at the intermediate time. Therefore, in such a case, it is difficult to detect the moving subject by using the difference between the reference image #0 and the detection image #4.

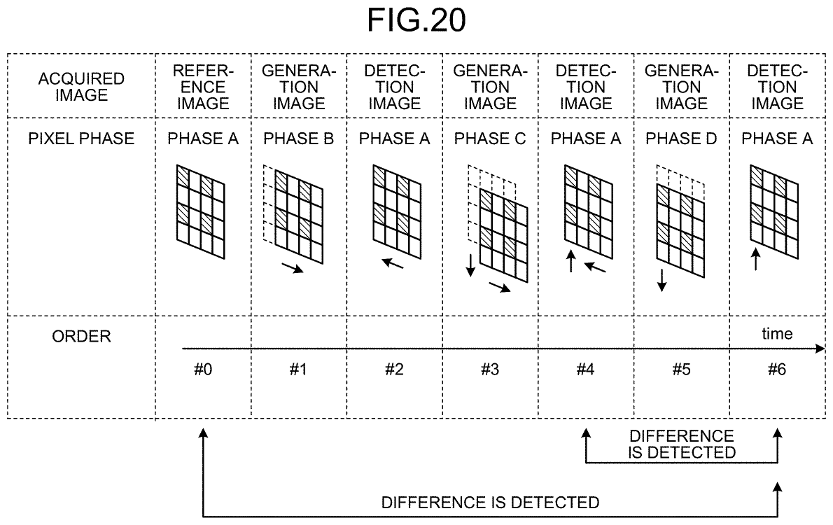

Therefore, a fourth embodiment of the present disclosure capable of detecting a moving subject even in such a case will be described with reference to FIG. 20. FIG. 20 is an explanatory diagram for explaining an image processing method according to the present embodiment.

In the present modification, as illustrated in FIG. 20, in addition to the acquisition of the reference image #0 in the phase A, the plurality of generation images #1, #3, and #5 in the phase B, the phase C, and the phase D, and the detection image #6 in the phase A, the acquisition of the detection images #2 and #4 in the phase A is added during the plurality of generation images #1, #3, and #5. That is, in the present embodiment, the image sensor unit 130 is sequentially shifted along the arrangement direction (horizontal direction, vertical direction) of the pixels 132 by one pixel (predetermined shift amount) in a manner that sequentially acquiring the generation image and the detection image in this order can be repeated.

Furthermore, in the present embodiment, in order to detect a moving subject having changing motion, not only the difference between the reference image #0 and the detection image #6 but also the difference between the detection image #4 and the detection image #6 is taken. Specifically, when applied to the example of FIG. 19, no difference is detected between the reference image #0 and the detection image #6, but a difference is detected between the detection image #4 and the detection image #6. Therefore, it is possible to detect a vehicle that is a moving subject. That is, in the present embodiment, by taking a difference with respect to the detection image #6 not only between the detection image #6 and the reference image #0 but also between the detection image #6 and the detection image #4 acquired in the adjacent order, detection can be performed with a plurality of differences. Therefore, a moving subject can be detected without fail.

In the present embodiment, not only the difference between the reference image #0 and the detection image #6 and the difference between the detection image #4 and the detection image #6 but also the difference between the reference image #0 and the detection image #2 and the difference between the detection image #2 and the detection image #4 may be used. In this case, the moving subject is also detected by the difference between the reference image #0 and the detection image #2 and the difference between the detection image #2 and the detection image #4. As described above, in the present embodiment, the moving subject can be detected without fail by using the plurality of differences.

### 6. Fifth Embodiment

In the embodiment described so far, the image sensor unit 130 is shifted along the arrangement direction of the pixels by the drive unit 140. However, in the embodiment of the present disclosure, the optical lens 110 may be shifted instead of the image sensor unit 130. Therefore, as a fifth embodiment of the present disclosure, an embodiment in which an optical lens 110a is shifted will be described.

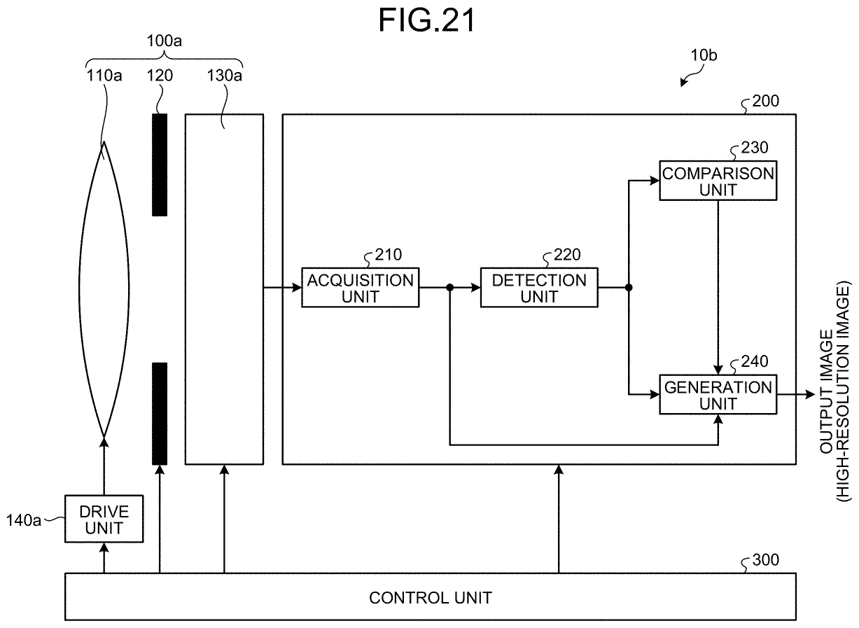

A configuration of an imaging device 10b according to the present embodiment will be described with reference to FIG. 21. FIG. 21 is an explanatory diagram for explaining an example of a configuration of the imaging device 10b according to the present embodiment. As illustrated in FIG. 21, the imaging device 10b according to the present embodiment can mainly include an imaging module 100a, the processing unit (image processing device) 200, and the control unit 300, similarly to the embodiments described above. Hereinafter, an outline of each unit included in the imaging device 10b will be sequentially described, but description of points common to the above embodiments will be omitted, and only different points will be described.

Similarly to the embodiments described above, the imaging module 100a forms an image of incident light from the subject 400 on an image sensor unit 130a to supply electric charge generated in the image sensor unit 130a to the processing unit 200 as an imaging signal. In detail, as illustrated in FIG. 21, the imaging module 100a includes the optical lens 110a, the shutter mechanism 120, the image sensor unit 130a, and a drive unit 140a. Hereinafter, details of each functional unit included in the imaging module 100a will be described.

Similarly to the embodiments described above, the optical lens 110a can collect light from the subject 400 and form an optical image on the plurality of pixels 132 (see FIG. 1) on a light receiving surface of the image sensor unit 130a. Furthermore, in the present embodiment, the optical lens 110a is shifted along the arrangement direction of the pixels by the drive unit 140a to be described later. The drive unit 140a can shift the optical lens 110a along the arrangement direction of the pixels, and can further shift the optical lens 110a in the horizontal direction and the vertical direction in units of pixels. In the present embodiment, for example, the optical lens 110a may be shifted by one pixel or 0.5 pixels. In the present embodiment, since the image forming position of the optical image is shifted by shifting the optical lens 110a, the image sensor unit 130a can sequentially acquire the reference image, the plurality of generation images, and the detection image similarly to the embodiments described above. Note that the present embodiment can be implemented in combination with the embodiments described above.

Furthermore, the embodiment of the present disclosure is not limited to shifting the image sensor unit 130 or shifting the optical lens 110a, and other blocks (the shutter mechanism 120, the imaging module 100, and the like) may be shifted as long as the image sensor unit 130 can sequentially acquire the reference image, the plurality of generation images, and the detection image.

### 7. Summary

As described above, according to each embodiment of the present disclosure described above, it is possible to more accurately determine whether or not a moving subject is included in an image. In detail, according to each embodiment, since the reference image #0 and the detection image #4 are acquired in the same phase (phase A), the form of mixing of the return signal is the same, and there is no case where a difference occurs even though the image is an image of a stationary subject. Therefore, according to each present embodiment, a stationary subject is not misidentified as a moving subject because of the different mixing forms of the return signal, and it is possible to accurately detect the moving subject. As a result, according to each embodiment, it is possible to generate a high-resolution image without breakage in the generated image.

### 8. Hardware Configuration

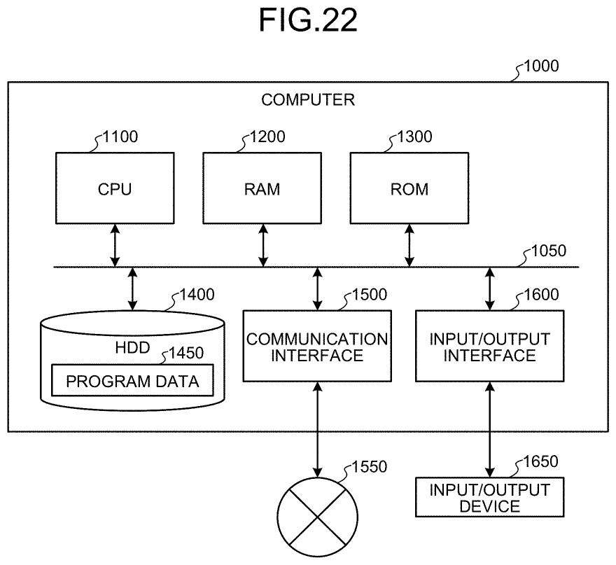

The information processing device such as the processing device according to each embodiment described above is realized by a computer 1000 having a configuration as illustrated in FIG. 22, for example. Hereinafter, the processing unit 200 of the present disclosure will be described as an example. FIG. 22 is a hardware configuration diagram illustrating an example of the computer 1000 that realizes a function of the processing unit 200. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on the program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that performs non-transient recording of a program executed by the CPU 1100, data used by such a program, and the like. Specifically, the HDD 1400 is a recording medium that records an image processing program according to the present disclosure as an example of a program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. In addition, the input/output interface 1600 may function as a media interface that reads a program and the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the processing unit 200 according to the embodiment of the present disclosure, the CPU 1100 of the computer 1000 executes the image processing program loaded on the RAM 1200 to implement the functions of the detection unit 220, the comparison unit 230, the generation unit 240, and the like. In addition, the HDD 1400 stores an image processing program and the like according to the present disclosure. Note that the CPU 1100 reads the program data 1450 from the HDD 1400 and executes the program data, but as another example, these programs may be acquired from another device via the external network 1550.

In addition, the information processing device according to the present embodiment may be applied to a system including a plurality of devices on the premise of connection to a network (or communication between devices), such as cloud computing. That is, the information processing device according to the present embodiment described above can also be realized as an information processing system that performs processing related to the image processing method according to the present embodiment by a plurality of devices, for example.

### 9. Supplement

Note that the embodiment of the present disclosure described above can include, for example, a program for causing a computer to function as the information processing device according to the present embodiment, and a non-transitory tangible medium on which the program is recorded. In addition, the program may be distributed via a communication line (including wireless communication) such as the Internet.

In addition, each step in the image processing of each embodiment described above may not necessarily be processed in the described order. For example, each step may be processed in an appropriately changed order. In addition, each step may be partially processed in parallel or individually instead of being processed in time series. Furthermore, the processing method of each step may not necessarily be processed according to the described method, and may be processed by another method by another functional unit, for example.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

In addition, the effects described in the present specification are merely illustrative or exemplary, and are not restrictive. That is, the technology according to the present disclosure can exhibit other effects obvious to those skilled in the art from the description of the present specification together with or instead of the above effects.

Note that the present technology can also have the configuration below.

(1) An imaging device comprising:

an imaging module including an image sensor in which a plurality of pixels for converting light into an electric signal is arranged;

a drive unit that moves a part of the imaging module in a manner that the image sensor can sequentially acquire a reference image under a predetermined pixel phase, a plurality of generation images, and a detection image under the predetermined pixel phase in this order; and

a detection unit that detects a moving subject based on a difference between the reference image and the detection image.

(2) The imaging device according to (1), wherein

the drive unit moves the image sensor.

(3) The imaging device according to (1), wherein

the drive unit moves an optical lens included in the imaging module.

(4) The imaging device according to any one of (1) to (3) further comprising:

a generation unit that generates an output image using the plurality of generation images based on a result of detection of the moving subject.

(5) The imaging device according to (4) further comprising:

a comparison unit that compares an area of a moving subject region corresponding to the moving subject with a predetermined threshold value, wherein

the generation unit changes a generation mode of the output image based on a result of the comparison.

(6) The imaging device according to (5), wherein

in a case where the area of the moving subject region is smaller than the predetermined threshold value,

the generation unit

combines a plurality of stationary subject images obtained by excluding the moving subject from each of the plurality of generation images to generate a composite image, and

generates the output image by fitting the reference image into the composite image.

(7) The imaging device according to (6), wherein

the generation unit includes

a difference detection unit that detects the difference between the reference image and the detection image,

a motion vector detection unit that detects a motion vector of the moving subject based on the reference image and the detection image,

an extraction map generation unit that estimates a position of the moving subject on an image at a timing when each of the generation images is acquired based on the difference and the motion vector, and generates a plurality of extraction maps including the moving subject disposed at the estimated position,

a stationary subject image generation unit that generates the plurality of stationary subject images by subtracting the corresponding extraction map from the plurality of generation images other than the reference image,

a composite image generation unit that combines the plurality of stationary subject images to generate the composite image, and

an output image generation unit that generates the output image by fitting the reference image into the composite image.

(8) The imaging device according to (5), wherein

in a case where the area of the moving subject region is larger than the predetermined threshold value,

the generation unit

predicts a motion of the moving subject based on the plurality of generation images sequentially acquired by the image sensor, and

generates the output image subjected to motion compensation processing based on a result of prediction.

(9) The imaging device according to any one of (1) to (8), wherein,

the drive unit moves a part of the imaging module in a manner that the image sensor can sequentially acquire the plurality of generation images under a pixel phase other than the predetermined pixel phase.

(10) The imaging device according to any one of (1) to (8), wherein,

the drive unit moves a part of the imaging module in a manner that the image sensor can repeatedly sequentially acquire the generation image and the detection image in this order.

(11) The imaging device according to (10), wherein

the detection unit detects the moving subject based on a difference between the reference image and each of the plurality of detection images.

(12) The imaging device according to (10), wherein

the detection unit detects the moving subject based on a difference between the plurality of the detection images acquired in a mutually adjacent order.

(13) The imaging device according to any one of (1) to (12), wherein

the plurality of pixels includes at least a plurality of first pixels, a plurality of second pixels, and a plurality of third pixels having different arrangements in the image sensor, and

the detection unit detects the moving subject based on a difference between the reference image and the detection image by the plurality of first pixels.

(14) The imaging device according to (13), wherein

a number of the plurality of first pixels in the image sensor is smaller than a number of the plurality of second pixels in the image sensor.

(15) The imaging device according to (13), wherein

a number of the plurality of first pixels in the image sensor is larger than a number of the plurality of second pixels in the image sensor, and is larger than a number of the plurality of third pixels in the image sensor.

(16) The imaging device according to (15), wherein

the detection image is included in the plurality of generation images.

(17) The imaging device according to any one of (1) to (8), wherein

the plurality of pixels includes at least a plurality of first pixels, a plurality of second pixels, and a plurality of third pixels having different arrangements in the image sensor, and

the detection unit includes

a first detection unit that detects the moving subject based on a difference between the reference image and the detection image by the plurality of first pixels, and

a second detection unit that detects the moving subject based on a difference between the reference image and the detection image by the plurality of second pixels.

(18) The imaging device according to (17), wherein

the detection unit further includes a third detection unit that detects the moving subject based on a difference between the reference image and the detection image by the plurality of third pixels.

(19) The imaging device according to any one of (1) to (8), wherein

the drive unit moves a part of the imaging module along an arrangement direction of the plurality of pixels by one pixel in a predetermined plane.

(20) The imaging device according to any one of (1) to (8), wherein

the drive unit moves a part of the imaging module along an arrangement direction of the plurality of pixels by 0.5 pixels in a predetermined plane.

(21) An image processing device comprising:

an acquisition unit that sequentially acquires a reference image under a predetermined pixel phase, a plurality of generation images, and a detection image under the predetermined pixel phase obtained by an image sensor in which a plurality of pixels for converting light into an electric signal is arranged, in this order; and

a detection unit that detects a moving subject based on a difference between the reference image and the detection image.

(22) An image processing method comprising:

sequentially acquiring a reference image under a predetermined pixel phase, a plurality of generation images, and a detection image under the predetermined pixel phase obtained by an image sensor in which a plurality of pixels for converting light into an electric signal is arranged, in this order; and

detecting a moving subject based on a difference between the reference image and the detection image.

(23) An imaging device comprising:

an image sensor in which a plurality of pixels for converting light into an electric signal is arranged;

a drive unit that moves the image sensor in a manner that the image sensor can sequentially acquire a reference image, a plurality of generation images, and a detection image in this order; and

a detection unit that detects a moving subject based on a difference between the reference image and the detection image, wherein

in the image sensor,

a position of at least a part of the plurality of pixels of a predetermined type at a time of acquiring the reference image overlaps a position of at least a part of the plurality of pixels of the predetermined type at a time of acquiring the detection image.

### REFERENCE SIGNS LIST

10, 10a, 10b IMAGING DEVICE
100, 100a IMAGING MODULE
110, 110a OPTICAL LENS
120 SHUTTER MECHANISM
130, 130a IMAGE SENSOR UNIT
132b, 132g, 132r PIXEL
140, 140a DRIVE UNIT
200, 200a PROCESSING UNIT
210 ACQUISITION UNIT
220, 220a, 220b, 220g, 220r DETECTION UNIT
230 COMPARISON UNIT
240 GENERATION UNIT
242 DIFFERENCE DETECTION UNIT
244, 264 MOTION VECTOR DETECTION UNIT
246 EXTRACTION MAP GENERATION UNIT
248 STATIONARY SUBJECT IMAGE GENERATION UNIT
250 COMPOSITE IMAGE GENERATION UNIT
252 OUTPUT IMAGE GENERATION UNIT
260, 276 UPSAMPLING UNIT
262 BUFFER UNIT
266 MOTION COMPENSATION UNIT
268 MASK GENERATION UNIT
270 MIXING UNIT
272 DOWNSAMPLING UNIT
278 ADDITION UNIT
274 SUBTRACTION UNIT
300 CONTROL UNIT
400 SUBJECT

1. An imaging device comprising:
an imaging module including an image sensor in which a plurality of pixels for converting light into an electric signal is arranged;
a drive unit that moves a part of the imaging module in a manner that the image sensor can sequentially acquire a reference image under a predetermined pixel phase, a plurality of generation images, and a detection image under the predetermined pixel phase in this order; and
a detection unit that detects a moving subject based on a difference between the reference image and the detection image.

2. The imaging device according to claim 1, wherein
the drive unit moves the image sensor.

3. The imaging device according to claim 1, wherein
the drive unit moves an optical lens included in the imaging module.

4. The imaging device according to claim 1 further comprising:
a generation unit that generates an output image using the plurality of generation images based on a result of detection of the moving subject.

5. The imaging device according to claim 4 further comprising:
a comparison unit that compares an area of a moving subject region corresponding to the moving subject with a predetermined threshold value, wherein
the generation unit changes a generation mode of the output image based on a result of the comparison.

6. The imaging device according to claim 5, wherein
in a case where the area of the moving subject region is smaller than the predetermined threshold value,
the generation unit
combines a plurality of stationary subject images obtained by excluding the moving subject from each of the plurality of generation images to generate a composite image, and
generates the output image by fitting the reference image into the composite image.

7. The imaging device according to claim 6, wherein
the generation unit includes
a difference detection unit that detects the difference between the reference image and the detection image,
a motion vector detection unit that detects a motion vector of the moving subject based on the reference image and the detection image,
an extraction map generation unit that estimates a position of the moving subject on an image at a timing when each of the generation images is acquired based on the difference and the motion vector, and generates a plurality of extraction maps including the moving subject disposed at the estimated position,
a stationary subject image generation unit that generates the plurality of stationary subject images by subtracting the corresponding extraction map from the plurality of generation images other than the reference image,
a composite image generation unit that combines the plurality of stationary subject images to generate the composite image, and
an output image generation unit that generates the output image by fitting the reference image into the composite image.

8. The imaging device according to claim 5, wherein
in a case where the area of the moving subject region is larger than the predetermined threshold value,
the generation unit
predicts a motion of the moving subject based on the plurality of generation images sequentially acquired by the image sensor, and
generates the output image subjected to motion compensation processing based on a result of prediction.

9. The imaging device according to claim 1, wherein,
the drive unit moves a part of the imaging module in a manner that the image sensor can sequentially acquire the plurality of generation images under a pixel phase other than the predetermined pixel phase.

10. The imaging device according to claim 1, wherein,
the drive unit moves a part of the imaging module in a manner that the image sensor can repeatedly sequentially acquire the generation image and the detection image in this order.

11. The imaging device according to claim 10, wherein
the detection unit detects the moving subject based on a difference between the reference image and each of the plurality of detection images.

12. The imaging device according to claim 10, wherein
the detection unit detects the moving subject based on a difference between the plurality of the detection images acquired in a mutually adjacent order.

13. The imaging device according to claim 1, wherein
the plurality of pixels includes at least a plurality of first pixels, a plurality of second pixels, and a plurality of third pixels having different arrangements in the image sensor, and
the detection unit detects the moving subject based on a difference between the reference image and the detection image by the plurality of first pixels.

14. The imaging device according to claim 13, wherein
a number of the plurality of first pixels in the image sensor is smaller than a number of the plurality of second pixels in the image sensor.

15. The imaging device according to claim 13, wherein
a number of the plurality of first pixels in the image sensor is larger than a number of the plurality of second pixels in the image sensor, and is larger than a number of the plurality of third pixels in the image sensor.

16. The imaging device according to claim 15, wherein
the detection image is included in the plurality of generation images.

17. The imaging device according to claim 1, wherein
the plurality of pixels includes at least a plurality of first pixels, a plurality of second pixels, and a plurality of third pixels having different arrangements in the image sensor, and
the detection unit includes
a first detection unit that detects the moving subject based on a difference between the reference image and the detection image by the plurality of first pixels, and
a second detection unit that detects the moving subject based on a difference between the reference image and the detection image by the plurality of second pixels.

18. The imaging device according to claim 17, wherein
the detection unit further includes a third detection unit that detects the moving subject based on a difference between the reference image and the detection image by the plurality of third pixels.

19. The imaging device according to claim 1, wherein
the drive unit moves a part of the imaging module along an arrangement direction of the plurality of pixels by one pixel in a predetermined plane.

20. The imaging device according to claim 1, wherein
the drive unit moves a part of the imaging module along an arrangement direction of the plurality of pixels by 0.5 pixels in a predetermined plane.

21. An image processing device comprising:
an acquisition unit that sequentially acquires a reference image under a predetermined pixel phase, a plurality of generation images, and a detection image under the predetermined pixel phase obtained by an image sensor in which a plurality of pixels for converting light into an electric signal is arranged, in this order; and
a detection unit that detects a moving subject based on a difference between the reference image and the detection image.

22. An image processing method comprising:
sequentially acquiring a reference image under a predetermined pixel phase, a plurality of generation images, and a detection image under the predetermined pixel phase obtained by an image sensor in which a plurality of pixels for converting light into an electric signal is arranged, in this order; and
detecting a moving subject based on a difference between the reference image and the detection image.
